(19) United States
(12) Patent Application Publication
(10) Pub. No.: US 2026/0059605 A1
(43) Pub. Date: Feb. 26, 2026

(54) COMMUNICATION METHOD AND RELAY APPARATUS

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/375,405

(22) Filed: Oct. 31, 2025

Related U.S. Application Data
(63) Continuation of application No. PCT/JP2024/017142, filed on May 8, 2024.

(30) Foreign Application Priority Data
May 11, 2023 (JP) 2023-078774

(51) Int. Cl. H04W 76/27; H04W 76/38; H04W 88/04

(52) U.S. Cl. CPC H04W 76/27; H04W 76/38; H04W 88/04

(57) ABSTRACT

A communication method executed by a relay apparatus including a relay device configured to perform a relay operation of relaying a radio signal transmitted between a base station and a user equipment, and a control terminal configured to receive a control signal used for control of the relay device from the base station includes: starting, by the control terminal, a timer restricting the initiation of a radio resource control (RRC) connection establishment procedure of transitioning to an RRC connected state upon having transitioned from the RRC connected state to an RRC idle state; restricting so as not to initiate the procedure, while the timer is running, in response to a cause of performing the RRC connection establishment not being a predetermined cause; and initiating the procedure, while the timer is running, in response to the cause of performing the RRC connection establishment being the predetermined cause.

### RELATED APPLICATIONS

The present application is a continuation based on PCT Application No. PCT/JP2024/017142, filed on May 8, 2024, which claims the benefit of Japanese Patent Application No. 2023-078774 filed on May 11, 2023. The content of which is incorporated by reference herein in their entirety.

### TECHNICAL FIELD

The present disclosure relates to a communication method and a relay apparatus used in a mobile communication system.

### BACKGROUND

In recent years, a mobile communication system of the fifth generation (5G) has been attracting attention. New Radio (NR), which is a radio access technology of the 5G system, is capable of wide-band transmission via a high frequency band compared to Long Term Evolution (LTE), which is a fourth-generation radio access technology.

Since radio signals (radio waves) in the high frequency band such as a millimeter wave band or a terahertz wave band have high rectilinearity, reduction of coverage of a base station is a problem. In order to solve such a problem, a repeater apparatus that is a type of relay apparatus relaying radio signals between the network and a user equipment and can be controlled from a network is attracting attention (see, for example, Non-Patent Document 1).

Such a repeater apparatus can extend the coverage of the base station while suppressing occurrence of interference by, for example, amplifying a radio signal received from the base station and transmitting the radio signal through directional transmission. Such a repeater apparatus is referred to as a Network-controlled Repeater (NCR).

### CITATION LIST

### Non-Patent Literature

Non-Patent Document 1: 3GPP Contribution: RP-213700, “New SI: Study on NR Network-controlled Repeaters”

### SUMMARY

A communication method according to a first aspect is a communication method executed by a relay apparatus including a relay device configured to perform a relay operation of relaying a radio signal transmitted between a network node and a user equipment and a control terminal configured to receive a control signal used for control of the relay device from the network node. The communication method includes: starting, by the control terminal, a timer restricting initiation of a radio resource control (RRC) connection establishment procedure of transitioning to an RRC connected state upon having transitioned from the RRC connected state to an RRC idle state; restricting so as not to initiate the procedure, while the timer is running, in response to a cause of performing the RRC connection establishment not being a predetermined cause; and initiating the procedure, while the timer is running, in response to the cause of performing the RRC connection establishment being the predetermined cause.

A relay apparatus according to a second aspect includes a relay device configured to perform a relay operation of relaying a radio signal transmitted between a network node and a user equipment and a control terminal configured to receive a control signal used for control of the relay device from the network node. The control terminal: starts a timer restricting initiation of a radio resource control (RRC) connection establishment procedure of transitioning to an RRC connected state upon having transitioned from the RRC connected state to an RRC idle state; restricts so as not to initiate the procedure, while the timer is running, in response to a cause of performing the RRC connection establishment being not a predetermined cause; and initiates the procedure, while the timer is running, in response to the cause of performing the RRC connection establishment being the predetermined cause.

A communication method according to a third aspect is a communication method executed by a relay apparatus including a relay device configured to perform a relay operation of relaying a radio signal transmitted between a network node and a user equipment and a control terminal configured to receive a control signal used for control of the relay device from the network node. The communication method includes: starting a timer, by the control terminal, upon having transitioned from a radio resource control (RRC) connected state to an RRC idle state; restricting, while the timer is running, initiation of an RRC connection establishment procedure of transitioning to the RRC connected state; and initiating the procedure when the timer expires.

A relay apparatus according to a fourth aspect includes a relay device configured to perform a relay operation of relaying a radio signal transmitted between a network node and a user equipment and a control terminal configured to receive a control signal used for control of the relay device from the network node. The control terminal includes: starting a timer when the control terminal has transitioned from a radio resource control (RRC) connected state to an RRC idle state; restricting, while the timer is running, initiation of an RRC connection establishment procedure of transitioning to the RRC connected state; and initiating the procedure when the timer expires.

### BRIEF DESCRIPTION OF THE DRAWINGS

FIG. 1 is a diagram illustrating a configuration of a mobile communication system according to an embodiment.

FIG. 2 is a diagram illustrating a configuration of a protocol stack of a wireless interface of a user plane handling data.

FIG. 3 is a diagram illustrating a configuration of a protocol stack of a wireless interface of a control plane handling signaling (control signal).

FIG. 4 is a diagram illustrating an example of an application scenario of the NCR apparatus (relay apparatus) according to a first embodiment.

FIG. 5 is a diagram illustrating an example of an application scenario of the NCR apparatus according to the first embodiment.

FIG. 6 is a diagram illustrating an example of a control method for the NCR apparatus according to the first embodiment.

FIG. 7 is a diagram illustrating an example of a configuration of a protocol stack in a mobile communication system including the NCR apparatus according to the first embodiment.

FIG. 8 is a diagram illustrating a specific example of a configuration of a mobile communication system 1 including the NCR apparatus according to the first embodiment.

FIG. 9 is a diagram illustrating a configuration example of the NCR apparatus according to the first embodiment.

FIG. 10 is a diagram illustrating a configuration of a user equipment (UE) according to the embodiment.

FIG. 11 is a diagram illustrating an example of a configuration of a gNB (base station) according to the embodiment.

FIG. 12 is a diagram illustrating an example of a first operation pattern according to the first embodiment.

FIG. 13 is a diagram illustrating an example of a second operation pattern according to the first embodiment.

FIG. 14 is a diagram illustrating an operation example of an NCR-MT according to a third operation pattern of the first embodiment.

FIG. 15 is a diagram illustrating an example of an operation of a mobile communication system according to the third operation pattern of the first embodiment.

FIG. 16 is a diagram illustrating another example of the operation of the mobile communication system according to the third operation pattern of the first embodiment.

FIG. 17 is a diagram illustrating an operation example of the NCR-MT according to a fourth operation pattern of the first embodiment.

FIG. 18 is a diagram for describing an RIS apparatus (relay apparatus) according to a second embodiment.

FIG. 19 is a diagram for describing the RIS apparatus (relay apparatus) according to the second embodiment.

### DESCRIPTION OF EMBODIMENTS

A mobile communication system according to an embodiment is described with reference to the drawings. In the description of the drawings, the same or similar parts are denoted by the same or similar reference numerals.

### (1) First Embodiment

A first embodiment will be described first. A relay apparatus according to an embodiment is a repeater apparatus (that is, an NCR apparatus) that can be controlled from a network.

### (1.1) Overview of Mobile Communication System

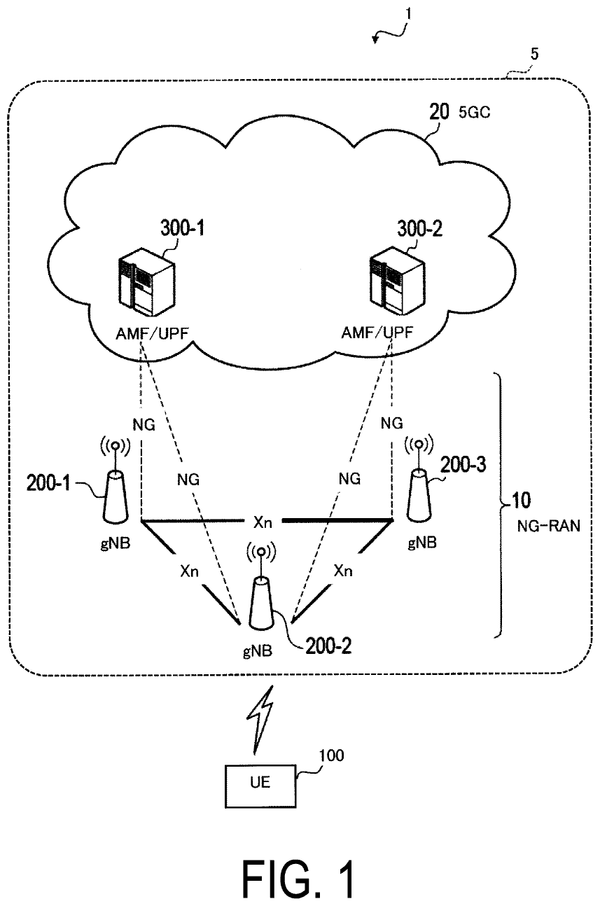

FIG. 1 is a diagram illustrating a configuration of a mobile communication system according to an embodiment.

A mobile communication system 1 complies with the 5th Generation System (5GS) of the 3rd Generation Partnership Project (3GPP) (trade name, the same applies below) standard. The description below takes the 5GS as an example, but a Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. Hereinafter, the NG-RAN 10 may be simply referred to as a RAN 10. The 5GC 20 may be simply referred to as a core network (CN) 20. The RAN 10 and the CN 20 constitute a network 5 of the mobile communication system 1.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term indicating a minimum unit of a wireless communication area. The “cell” is also used as a term indicating a function or a resource for performing wireless communication with the UE 100. One cell belongs to one carrier frequency (hereinafter, simply referred to as a “frequency”).

The gNB 200 may be functionally divided into a Central Unit (CU) and a Distributed Unit (DU). The CU controls the DU. The CU is a unit including upper layers included in a protocol stack described below, such as an RRC layer, an SDAP layer, and a PDCP layer, for example. The CU is connected to a core network via an NG interface which is a backhaul interface. The CU is connected to a neighboring base station via the Xn interface, which is an inter-base station interface. The DU forms a cell. The DU 202 is a unit including lower layers included in the protocol stack described below, such as an RLC layer, a MAC layer, and a PHY layer, for example. The DU is connected to the CU via an F1 interface which is a fronthaul interface.

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

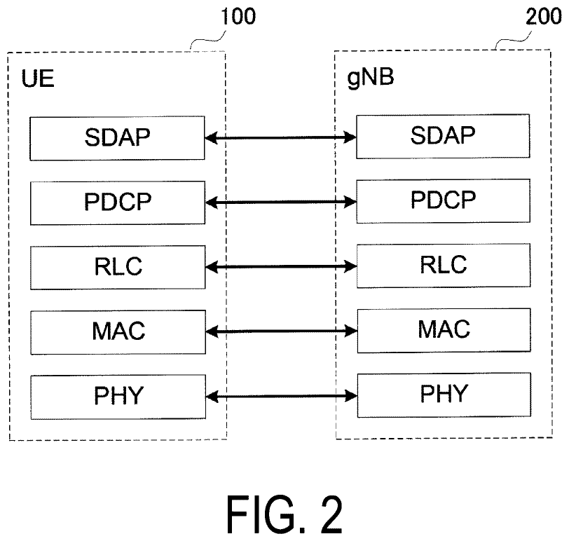

FIG. 2 is a diagram illustrating a configuration of a protocol stack of a wireless interface of a user plane handling data.

A wireless interface protocol of the user plane includes a PHYsical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of PDCCH using a radio network temporary identifier (RNTI) and acquires successfully decoded DCI as DCI addressed to the UE. CRC bits scrambled by the RNTI are added to the DCI transmitted from the gNB 200.

The gNB 200 transmits a synchronization signal block (Synchronization Signal/PBCH block (SSB)). For example, the SSB includes four consecutive Orthogonal Frequency Division Multiplex (OFDM) symbols, and a primary synchronization signal (PSS), a secondary synchronization signal (SSS), a physical broadcast channel (PBCH)/master information block (MIB), and a demodulation reference signal (DMRS) of the PBCH are disposed. A bandwidth of the SSB is, for example, a bandwidth of 240 consecutive subcarriers, that is, 20 RB.

The MAC layer performs priority control of data, retransmission processing through hybrid ARQ (Hybrid Automatic Repeat reQuest (HARQ)), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer uses the functions of the MAC layer and the PHY layer to transmit data to the RLC layer on the receiving side. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QoS) control performed by a core network and a radio bearer as the unit of QoS control performed by an Access Stratum (AS). Note that when the RAN is connected to an EPC, the SDAP is not necessary.

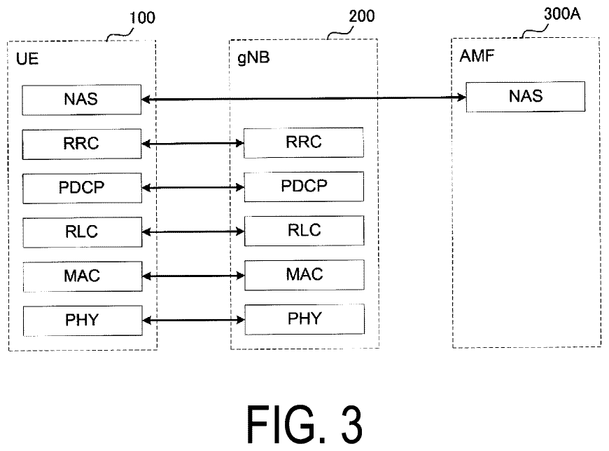

FIG. 3 is a diagram illustrating a configuration of a protocol stack of a wireless interface of a control plane handling signaling (a control signal).

The protocol stack of the wireless interface of the control plane includes a Radio Resource Control (RRC) layer and a Non-Access Stratum (NAS) layer instead of the SDAP layer illustrated in FIG. 2.

RRC signaling for various configurations is transmitted between the RRC layer of the UE 100 and the RRC layer of the gNB 200. The RRC layer controls the logical channel, the transport channel, and the physical channel according to the establishment, re-establishment and release of radio bearers. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS layer, which is located above the RRC layer, performs session management, mobility management, and the like. NAS signaling is transmitted between the NAS layer of the UE 100 and the NAS layer of an AMF 300A. Note that the UE 100 has an application layer and the like in addition to the wireless interface protocol. A layer lower than the NAS layer is referred to as Access Stratum (AS).

### (1.2) Example of Application Scenario of Relay Apparatus

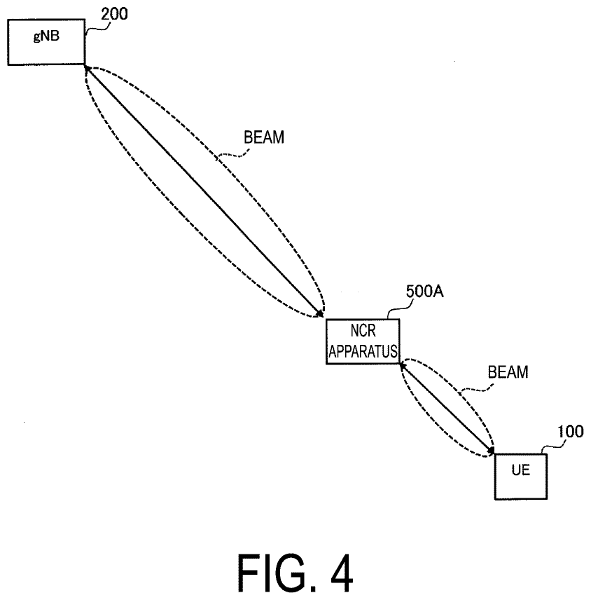

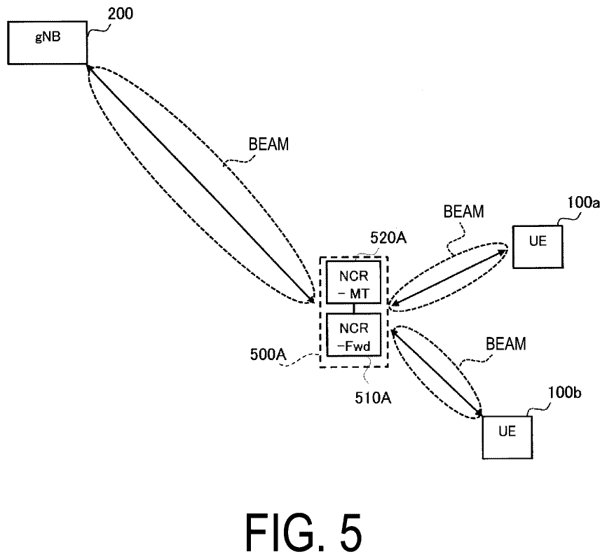

Each of FIGS. 4 and 5 is a diagram illustrating an example of an application scenario of an NCR apparatus according to the embodiment.

The 5G/NR is capable of wide-band transmission via a high frequency band compared to the 4G/LTE. Since radio signals in the high frequency band such as a millimeter wave band or a terahertz wave band have high rectilinearity, a problem is reduction of coverage of the gNB 200. In FIG. 4, the UE 100 may be located outside a coverage area of the gNB 200, for example, outside an area where the UE 100 can receive radio signals directly from the gNB 200. The UE 100 may not communicate with the gNB 200 within a line of sight because of obstacles existing between the gNB 200 and the UE 100.

As illustrated in FIG. 4, an NCR apparatus 500A that can be controlled from a network 5 is introduced into the mobile communication system 1. The NCR apparatus 500A is a repeater apparatus (500A) that is a type of relay apparatus for relaying a radio signal between the gNB 200 and the UE 100. Such a repeater apparatus may be called a smart repeater apparatus.

For example, the NCR apparatus 500A amplifies a radio signal (radio wave) received from the gNB 200 and transmits the radio signal through directional transmission. Specifically, the NCR apparatus 500A receives a radio signal transmitted by the gNB 200 through beamforming. The NCR apparatus 500A amplifies the received radio signal without demodulation and modulation and transmits the amplified radio signal through the directional transmission. Here, the NCR apparatus 500A may transmit the radio signal with a fixed directivity (beam). The NCR apparatus 500A may transmit a radio signal with a variable (adaptive) directional beam. This can efficiently extend the coverage of the gNB 200.

Also, as illustrated in FIG. 5, a new UE (hereinafter referred to as “NCR-MT (Mobile termination)”) 100B, which is a type of control terminal for controlling the NCR apparatus 500A, is introduced. That is, the NCR apparatus 500A includes an NCR-Fwd (Forward) 510A, which is a type of a relay device that relays a radio signal transmitted between the gNB 200 and the UE 100, specifically, changes a propagation state of the radio signal without demodulating or modulating the radio signal, and an NCR-MT 520A that performs wireless communication with the gNB 200 to control the NCR-Fwd 510A.

Thus, the NCR-MT 520A controls the NCR apparatus 500A in cooperation with the gNB 200 by establishing a wireless connection to the gNB 200 and performing wireless communication to the gNB 200. Accordingly, efficient coverage extension can be realized using the NCR apparatus 500A. The NCR-MT 520A controls the NCR apparatus 500A according to control from the gNB 200. The NCR-MT 520A also has the same function as that of the UE 100.

The NCR-MT 520A may be configured separately from the NCR-Fwd 510A. For example, the NCR-MT 520A may be located near the NCR-Fwd 510A and may be electrically connected to the NCR-Fwd 510A. The NCR-MT 520A may be connected to the NCR-Fwd 510A by wire or wireless. Alternatively, the NCR-MT 520A may be configured integrally with the NCR-Fwd 510A. The NCR-MT 520A and the NCR-Fwd 510A may be fixedly installed at a coverage edge (cell edge) of the gNB 200, or on a wall surface or window of any building, for example. The NCR-MT 520A and the NCR-Fwd 510A may be installed, for example, in a vehicle or the like and may be mobile. One NCR-MT 520A may control the plurality of NCR-Fwds 510A.

The configuration is not limited to a configuration in which the NCR-MT 520A directly controls one or more NCR-Fwds 510A, and may be configuration in which the NCR-MT 520A indirectly controls one or more NCR-Fwds 510A. For example, the NCR-MT 520A may control one or more NCR-Fwds 510A via an upper layer (for example, an application layer).

In the example illustrated in FIG. 5, the NCR apparatus 500A (NCR-Fwd 510A) dynamically or semi-statically changes a beam to be transmitted or received. For example, the NCR-Fwd 510A forms a beam toward each of a UE 100a and a UE 100b. The NCR-Fwd 510A may also form a beam toward the gNB 200. For example, in a communication resource between the gNB 200 and the UE 100a, the NCR-Fwd 510A transmits a radio signal received from the gNB 200 toward the UE 100a through beamforming and/or transmits a radio signal received from the UE 100a toward the gNB 200 through beamforming. In a communication resource between the gNB 200 and the UE 100b, the NCR-Fwd 510A transmits the radio signal received from the gNB 200 toward the UE 100b through beamforming and/or transmits the radio signal received from the UE 100b toward the gNB 200 through beamforming. Instead of or in addition to the beam forming, the NCR-Fwd 510A may perform null forming (so-called null steering) toward the UE 100 which is not a communication partner (not illustrated) and/or a neighboring gNB 200 (not illustrated) to curb interference.

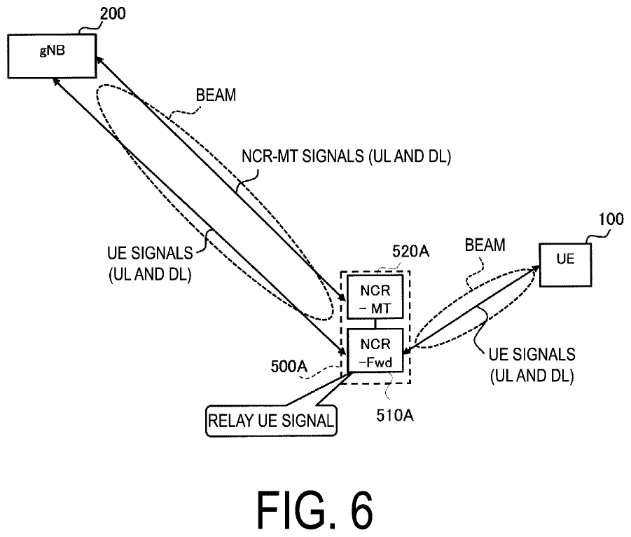

FIG. 6 is a diagram illustrating an example of a control method for the NCR apparatus 500A according to the embodiment.

The NCR-Fwd 510A relays a radio signal (also referred to as “UE signal”) between the gNB 200 and the UE 100. The UE signal includes an uplink signal transmitted from the UE 100 to the gNB 200 (referred to as “UE-UL signal”) and a downlink signal transmitted from the gNB 200 to the UE 100 (referred to as “UE-DL signal”). The NCR-Fwd 510A relays the UE-UL signal from the UE 100 to the gNB 200 and relays the UE-DL signal from the gNB 200 to the UE 100. The radio link between the NCR-Fwd 510A and the UE 100 is also referred to as an “access link”. The radio link between the NCR-Fwd 510A and the gNB 200 is also referred to as a “backhaul link”.

The NCR-MT 520A transmits and receives a radio signal (herein referred to as an “NCR-MT signal”) to and from the gNB 200. The NCR-MT signal includes an uplink signal transmitted from the NCR-MT 520A to the gNB 200 (referred to as an “NCR-MT-UL signal”), and a downlink signal transmitted from the gNB 200 to the NCR-MT 520A (referred to as an “NCR-MT-DL signal”). The NCR-MT-DL signal includes signaling for controlling the NCR apparatus 500A (for example, an NCR control signal). A radio link between the NCR-MT 520A and the gNB 200 is also referred to as a “control link”.

The gNB 200 directs a beam to the NCR-MT 520A based on the NCR-MT-UL signal from the NCR-MT 520A. Since the NCR apparatus 500A and the NCR-MT 520A are co-located, the beam is also eventually directed to the NCR-Fwd 510A when the backhaul link and the control link have the same frequency and the gNB 200 directs a beam to the NCR-MT 520A. The gNB 200 transmits the NCR-MT-DL signal and the UE-DL signal using the beam. The NCR-MT 520A receives the NCR-MT-DL signal. When the NCR-Fwd 510A and the NCR-MT 520A are at least partially integrated, a function (for example, antennas) for transmitting or receiving, or relaying UE signals and/or NCR-MT signals may be integrated in the NCR-Fwd 510A and the NCR-MT 520A. The beam includes a transmission beam and/or a reception beam. The beam is a general term for transmission and/or reception under control for maximizing power of a transmission wave and/or a reception wave in a specific direction by adjusting/adapting an antenna weight or the like.

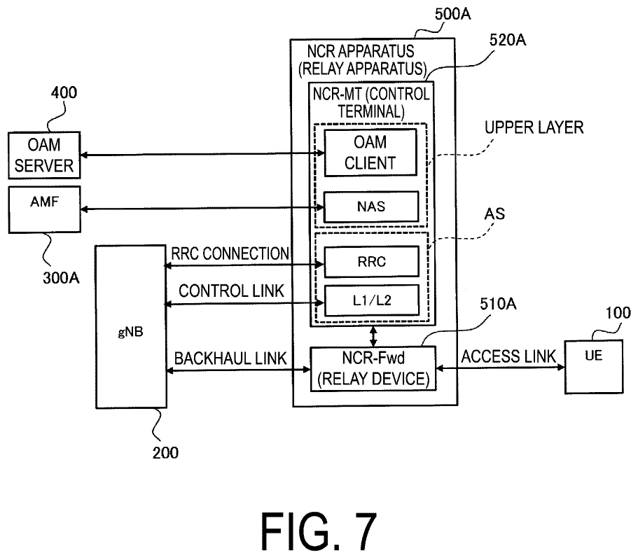

FIG. 7 is a diagram for describing an example of a configuration of a protocol stack in the NCR apparatus 500A according to the embodiment.

The NCR-Fwd 510A relays a radio signal transmitted and received between the gNB 200 and the UE 100. The NCR-Fwd 510A has a Radio Frequency (RF) function of amplifying and relaying a received radio signal, and performs directional transmission through beamforming (for example, analog beamforming).

The NCR-MT 520A includes entities of layers of a layer 1 and/or a layer 2 (L1/L2), the RRC, and the NAS. The L1/L2 (in particular, PHY, MAC) of the NCR-MT 520A and the RRC are also referred to as “the AS of the NCR-MT 520A”.

The NCR-MT 520A may include at least one of an Operation, Administration, Maintenance (OAM) client that communicates with an OAM server 400, a NAS layer that communicates with the AMF 300A, and an F1-Application Protocol (AP) layer. The OAM client, the NAS layer, and the F1-AP layer of the NCR-MT 520A are also referred to as “upper layers of the NCR-MT 520A” with reference to the AS of the NCR-MT 520A.

A backhaul link is established between the gNB 200 and the NCR-Fwd 510A. An access link is established between the UE 100 and the NCR-Fwd 510A. The NCR-Fwd 510A relays a radio signal transmitted between the gNB 200 and the UE 100 via the backhaul link and the access link. The NCR-Fwd 510A changes a propagation state of the radio signal without demodulating or modulating the radio signal.

A control link is established between the gNB 200 and the L1/L2 of the NCR-MT 520A. The L1/L2 of the NCR-MT 520A transmits and receives L1/L2 signaling to and from the gNB 200 via the control link. An RRC connection is established between the gNB 200 and the RRC of the NCR-MT 520A. The RRC of the NCR-MT 520A transmits and receives an RRC message to and from the gNB 200 via the RRC connection. The NCR-MT 520A receives downlink signaling (also referred to as an “NCR control signal” or simply “control signal”) from the gNB 200 via the RRC connection and/or the control link.

The gNB 200 (transmitter 210) transmits the NCR control signal to the NCR-MT 520A. The NCR control signal may be an RRC message, which is a control signal of the RRC layer (that is, layer 3). The NCR control signal may be a MAC control element (CE), which is a control signal of the MAC layer (that is, layer 2). The NCR control signal may be downlink control information (DCI), which is a control signal of the PHY layer (that is, layer 1). The NCR control signal may be UE-specific signaling. The NCR control signal may be broadcast signaling. The NCR control signal may be a fronthaul message (for example, F1-AP message). When the NCR-MT 520A is a type or part of a base station, the NCR-MT 520A may communicate with the gNB 200 via an AP of Xn (Xn-AP), which is an inter-base station interface.

Hereinafter, the NCR control signal transmitted in the RRC message (and/or MAC CE) and used for static or semi-static control of the NCR-Fwd 510A is also referred to as “NCR configuration information” or simply “configuration information”. Such configuration information may be referred to as a “Side Control Configuration”. Here, the RRC message may be an RRC Reconfiguration message. The NCR configuration information includes, for example, information for configuring on/off of the NCR-Fwd 510A. The NCR configuration information may include, for example, information for semi-static beam configuration of the NCR-Fwd 510A.

On the other hand, the NCR control signal transmitted in the L1/L2 signaling, that is, the DCI (and/or MAC CE) and used for dynamic control of the NCR-Fwd 510A is also referred to as “NCR control information” or simply “control information”. The NCR control information may be referred to as “Side Control Information”. Cyclic Redundancy Code (CRC) bits of the PDCCH carrying the NCR control information are scrambled by a newly introduced dedicated RNTI. The dedicated RNTI is also referred to as “NCR-RNTI”. The NCR control information may include, for example, information for dynamic beam control of the NCR-Fwd 510A. The NCR configuration information may include information for instructing dynamic on/off of the NCR-Fwd 510A.

For example, when the NCR-MT 520A is in the RRC connected state, the NCR apparatus 500A can turn on or off the NCR-Fwd 510A in accordance with the NCR control information received from the gNB 200. On the other hand, after the NCR-MT 520A transitions to an RRC inactive state, the NCR apparatus 500A can turn on or off the NCR-Fwd 510A according to the latest (last) configuration information received from the gNB 200.

Further, the NCR control signal (for example, NCR configuration information by RRC and/or NCR control information by L1/L2 signaling) held by the NCR apparatus 500A (NCR-MT 520A) may be referred to as an NCR-Fwd context.

Also, when a radio link failure (RLF) with the gNB 200 is detected by the NCR-MT 520A, the NCR-MT 520A executes cell selection and triggers RRC connection re-establishment (also referred to as “RRC re-establishment”). Here, when the NCR-MT 520A enters the RRC idle state because a suitable cell cannot be found in the cell selection, the NCR apparatus 500A turns off the NCR-Fwd 510A. The NCR-Fwd 510A is off during an RRC connection re-establishment procedure.

The NCR control signal may include frequency control information for designating a center frequency of a radio signal (for example, a component carrier) that is a relay target in the NCR-Fwd 510A. When the NCR control signal received from the gNB 200 includes the frequency control information, the NCR-MT 520A (controller 523) controls the NCR-Fwd 510A such that the NCR-Fwd 510A relays a radio signal whose center frequency is indicated by the frequency control information as a target (step S2A). The NCR control signal may include a plurality of pieces of frequency control information for designating center frequencies different from each other. Since the NCR control signal includes the frequency control information, the gNB 200 can designate the center frequency of the radio signal to be relayed by the NCR-Fwd 510A via the NCR-MT 520A.

The NCR control signal may include mode control information for designating an operation mode of the NCR-Fwd 510A. The mode control information may be associated with the frequency control information (center frequency). The operation mode may be any one of a mode in which the NCR-Fwd 510A performs omnidirectional transmission and/or reception, a mode in which the NCR-Fwd 510A performs fixed-directional transmission and/or reception, a mode in which the NCR-Fwd 510A performs transmission and/or reception with a variable directional beam, and a mode in which the NCR-Fwd 510A performs Multiple Input Multiple Output (MIMO) relay transmission. The operation mode may be either a beamforming mode (that is, a mode in which improvement of a desired wave is emphasized) and a null steering mode (that is, a mode in which curbing of an interference wave is emphasized). When the NCR control signal received from the gNB 200 includes the mode control information, the NCR-MT 520A (controller 523) controls the NCR-Fwd 510A such that the NCR-Fwd 510A operates in the operation mode indicated by the mode control information (step S2A). Since the NCR control signal includes the mode control information, the gNB 200 can designate the operation mode of the NCR-Fwd 510A via the NCR-MT 520A.

Here, a mode in which the NCR apparatus 500A performs omnidirectional transmission and/or reception is a mode in which the NCR-Fwd 510A performs relaying in all directions, and may be referred to as an omni mode. The mode in which the NCR-Fwd 510A performs fixed-directional transmission and/or reception may be a directivity mode achieved by one directional antenna. The mode may be a beamforming mode achieved by applying fixed phase and amplitude control (antenna weight control) to a plurality of antennas. Any of these modes may be designated (set) from the gNB 200 to the NCR-MT 520A. The mode in which the NCR-Fwd 510A performs transmission and/or reception with a variable directional beam may be a mode for performing analog beamforming. The mode may be a mode in which digital beamforming is performed. The mode may be a mode in which hybrid beamforming is performed. The mode may be a mode for forming an adaptive beam specific to the UE 100.

Any of these modes may be designated (set) from the gNB 200 to the NCR-MT 520A. In the operation mode in which beamforming is performed, beam control information to be described below may be provided from the gNB 200 to the NCR-MT 520A. The mode in which the NCR apparatus 500A performs MIMO relay transmission may be a mode for performing Single-User (SU) spatial multiplexing. The mode may be a mode for performing Multi-User (MU) spatial multiplexing. The mode may be a mode for performing transmission diversity. Any of these modes may be designated (set) from the gNB 200 to the NCR-MT 520A. The operation mode may include a mode in which relay transmission by the NCR-Fwd 510A is turned on (activated) and a mode in which the relay transmission by the NCR-Fwd 510A is turned off (deactivated). Any of these modes may be designated (set) from the gNB 200 to the NCR-MT 520A in the NCR control signal.

The NCR control signal may include beam control information for designating a transmission direction, a transmission weight, or a beam pattern when the NCR-Fwd 510A performs directional transmission. The beam control information may be associated with the frequency control information (center frequency). The beam control information may include a Precoding Matrix Indicator (PMI). The beam control information may include beam forming angle information. When the NCR control signal received from the gNB 200 includes beam control information, the NCR-MT 520A (controller 523) controls the NCR-Fwd 510A to form a transmission directivity (beam) indicated by the beam control information. When the NCR control signal includes the beam control information, the gNB 200 can control the transmission directivity of the NCR apparatus 500A via the NCR-MT 520A.

The NCR control signal may include output control information for designating a degree to which the NCR-Fwd 510A amplifies the radio signal (amplification gain) or the transmission power. The output control information may be information indicating a difference value (that is, a relative value) between a current amplification gain or transmission power and a target amplification gain or transmission power. When the NCR control signal received from the gNB 200 includes output control information, the NCR-MT 520A (controller 523) controls the NCR-Fwd 510A so that the NCR-Fwd 510A performs change to the amplification gain or transmission power indicated by the output control information. The output control information may be associated with frequency control information (center frequency). The output control information may be information for designating any one of an amplification gain, a beamforming gain, and an antenna gain of the NCR-Fwd 510A. The output control information may be information for designating transmission power of the NCR-Fwd 510A.

When one NCR-MT 520A controls the plurality of NCR-Fwds 510A, the gNB 200 (transmitter 210) may transmit an NCR control signal to the NCR-MT 520A for each NCR-Fwd 510A. In this case, the NCR control signal may include an identifier of the corresponding NCR-Fwd 510A (NCR identifier). The NCR-MT 520A (controller 523) controlling the plurality of NCR-Fwds 510A determines the NCR-Fwd 510A to which the NCR control signal is applied, based on the NCR identifier included in the NCR control signal received from the gNB 200. The NCR identifier may be transmitted together with the NCR control signal from the NCR-MT 520A to the gNB 200 even when the NCR-MT 520A controls only one NCR-Fwd 510A.

Thus, the NCR-MT 520A (controller 523) controls the NCR-Fwd 510A based on the NCR control signal from the gNB 200. This enables the gNB 200 to control the NCR-Fwd 510A via the NCR-MT 520A.

### (1.3) Example of Configuration of Each Apparatus

An example of a configuration of each apparatus in the mobile communication system 1 according to the embodiment will be described.

### (1.3.1) Example of Configuration of Relay Apparatus

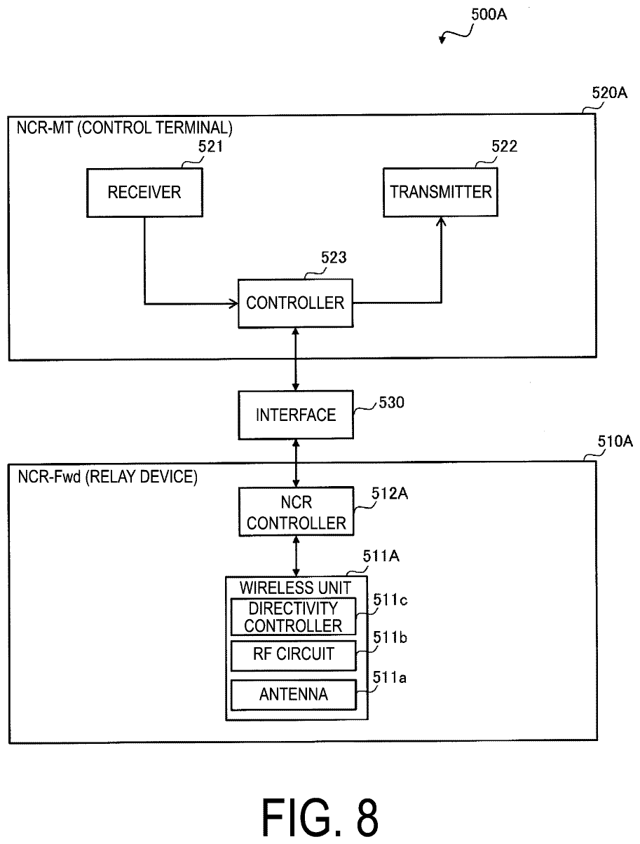

FIG. 8 is a diagram illustrating an example of a configuration of the NCR apparatus 500A (relay apparatus) according to the embodiment. The NCR apparatus 500A includes an NCR-Fwd 510A, an NCR-MT 520A, and an interface 530.

The NCR-Fwd 510A includes a wireless unit 511A and an NCR controller 512A. The wireless unit 511A includes an antenna 511a including a plurality of antennas (a plurality of antenna elements), an RF circuit 511b including an amplifier, and a directivity controller 511c that controls directivity of the antenna 511a. The RF circuit 511b amplifies and relays (transmits) radio signals transmitted and received by the antenna 511a. The RF circuit 511b may convert a radio signal, which is an analog signal, into a digital signal, and reconvert the digital signal into an analog signal after digital signal processing. The directivity controller 511c may perform analog beamforming through analog signal processing. The directivity controller 511c may perform digital beamforming through digital signal processing. The directivity controller 511c may perform analog and digital hybrid beamforming. The NCR controller 512A controls the wireless unit 511A in response to a control signal from the NCR-MT 520A. The NCR controller 512A may include at least one processor.

The NCR-MT 520A includes a receiver 521, a transmitter 522, and a controller 523. The receiver 521 performs various types of reception under control of the controller 523. The receiver 521 includes an antenna and a reception device. The reception device converts a radio signal received by the antenna (radio signal) into a baseband signal (a reception signal) and outputs the reception signal to the controller 523. The transmitter 522 performs various types of transmission under control of the controller 523. The transmitter 522 includes an antenna and a transmission device. The transmission device converts a baseband signal (a transmission signal) output by the controller 523 into a radio signal and transmits the radio signal from the antenna. The controller 523 performs various types of controls in the NCR-MT 520A. The operation of the NCR-MT 520A (and the NCR apparatus 500A) described above and to be described below may be an operation controlled by the controller 523. The controller 523 includes at least one processor and at least one memory. The memory stores programs executed by the processor and information used in processing by the processor. The processor may include a baseband processor and a Central Processing Unit (CPU). The baseband processor performs modulation/demodulation and encoding/decoding of the baseband signal. The CPU executes programs stored in the memory to perform various processes. The controller 523 executes a function of at least one layer selected from the group consisting of the PHY, the MAC, the RRC, and the F1-AP.

The interface 530 electrically or logically connects the NCR-Fwd 510A and the NCR-MT 520A. The controller 523 of the NCR-MT 520A controls the NCR-Fwd 510A via the interface 530. The interface 530 may be a logical entity of an upper layer (for example, an application layer).

In an embodiment, the receiver 521 of the NCR-MT 520A receives signaling (NCR control signal) used to control the NCR apparatus 500A from the gNB 200 through wireless communication. The controller 523 of the NCR-MT 520A controls the NCR apparatus 500A based on the signaling. This enables the gNB 200 to control the NCR-Fwd 510A via the NCR-MT 520A.

### (1.3.2) Example of Configuration of User Equipment

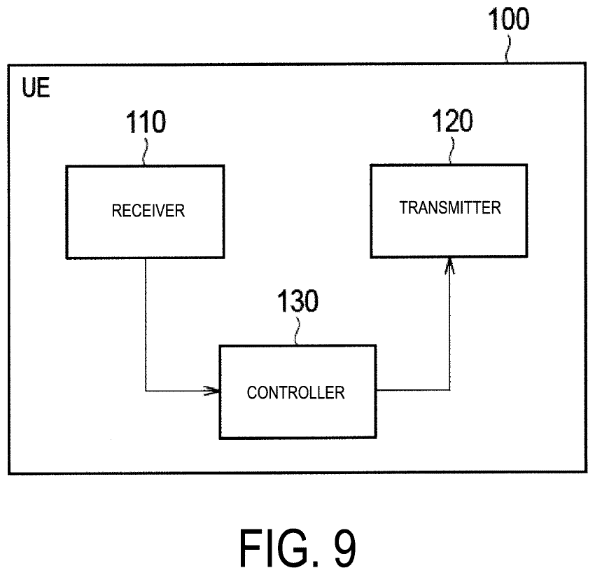

FIG. 9 is a diagram illustrating a configuration of the UE 100 (user equipment) according to the embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under the control of the controller 130. The receiver 110 includes an antenna and a reception device. The reception device converts a radio signal received by the antenna into a baseband signal (a reception signal) and outputs the resulting signal to the controller 130.

The transmitter 120 performs various types of transmission under the control of the controller 130. The transmitter 120 includes an antenna and a transmission device. The transmission device converts a baseband signal (a transmission signal) output by the controller 130 into a radio signal and transmits the resulting signal from an antenna.

The controller 130 performs various controls and processes in the UE 100. Such processing includes processing of respective layers to be described below. The operations of the UE 100 described above and to be described below may be operations under the control of the controller 130. The controller 130 includes at least one processor and at least one memory. The memory stores programs executed by the processor and information used in processing by the processor. The processor may include a baseband processor and a CPU. The baseband processor performs modulation/demodulation and encoding/decoding of the baseband signal. The CPU executes programs stored in the memory to perform various processes.

### (1.3.3) Example of Configuration of Base Station

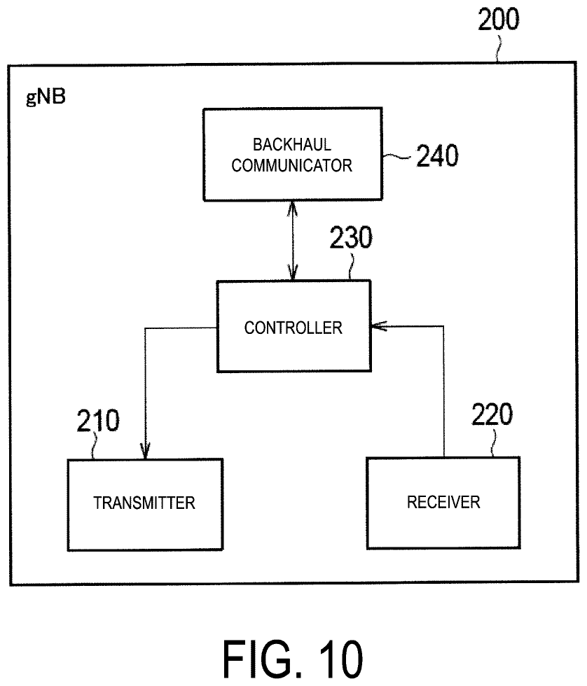

FIG. 10 is a diagram illustrating an example of a configuration of the gNB 200 (base station) according to the embodiment. The gNB 200 includes a transmitter 210, a receiver 220, a controller 230, and a backhaul communicator 240.

The transmitter 210 performs various types of transmission under the control of the controller 230. The transmitter 210 includes an antenna and a transmission device. The transmission device converts a baseband signal (a transmission signal) output by the controller 230 into a radio signal and transmits the resulting signal from an antenna. The receiver 220 performs various types of reception under the control of the controller 230. The receiver 220 includes an antenna and a reception device. The reception device converts a radio signal received by the antenna into a baseband signal (a reception signal) and outputs the resulting signal to the controller 230. The transmitter 210 and the receiver 220 may be capable of beamforming using a plurality of antennas.

The controller 230 performs various types of control for the gNB 200. The operations of the gNB 200 described above and to be described below may be also performed under the control of the controller 230. The controller 230 includes at least one processor and at least one memory. The memory stores programs executed by the processor and information used in processing by the processor. The processor may include a baseband processor and a CPU. The baseband processor performs modulation/demodulation and encoding/decoding of the baseband signal. The CPU executes programs stored in the memory to perform various processes.

The backhaul communicator 240 is connected to a neighboring base station via the inter-base station interface. The backhaul communicator 240 is connected to the AMF/UPF 300 via the interface between a base station and the core network. The gNB may include a Central Unit (CU) and a Distributed Unit (DU) (that is, functions are divided), and both units may be connected via an F1 interface.

In the embodiment, the transmitter 210 of the gNB 200 transmits signaling (NCR control signal) used for control of the NCR-Fwd 510A to the NCR-MT 520A through wireless communication. This enables the gNB 200 to control the NCR apparatus 500A via the NCR-MT 520A.

(1.4) Operation according to First Embodiment

In the first embodiment, a case that the gNB 200 causes the NCR-MT 520A to transition to the RRC idle state (that is, releases the RRC connection of the NCR-MT 520A) is mainly assumed.

### (1.4.1) First Operation Pattern

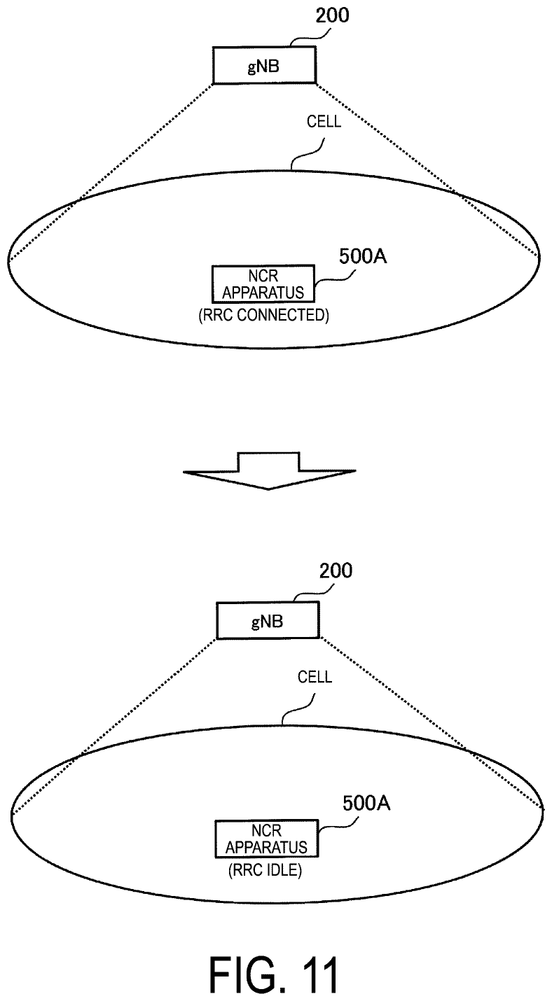

FIG. 11 is a diagram for describing a first operation pattern according to the first embodiment.

The gNB 200 may intentionally cause the NCR-MT 520A to transition to the RRC idle state for reasons such as power saving of the NCR apparatus 500A and/or network congestion. In the first embodiment, after the NCR-MT 520A transitions to the RRC idle state, the NCR apparatus 500A operates (for example, turns on or off the NCR-Fwd 510A) in accordance with the last NCR control signal (particularly, the NCR configuration information) received from the gNB 200.

However, the gNB 200 cannot start paging for the NCR-MT 520A in the RRC idle state. That is, the gNB 200 cannot cause the NCR-MT 520A in the RRC idle state to transition to the RRC connected state by paging.

After the NCR-MT 520A transitions to the RRC idle state, on the assumption of a case that the RRC idle state is continuously maintained, the NCR-Fwd 510A continuously performs the operation in accordance with the latest configuration information. For example, when the NCR apparatus 500A in the RRC idle state continuously turns on the NCR-Fwd 510A, interference or the like may occur that is unexpected by the network 5. In the first operation pattern, therefore, the NCR apparatus 500A controls the NCR-Fwd 510A with the latest configuration only during a certain period of time after the transition to the RRC idle state. In other words, there is provided a time limit during which the NCR apparatus 500A in the RRC idle state continues the operation in accordance with the latest configuration information (for example, putting the NCR-Fwd 510A to an on state).

Specifically, the NCR-MT 520A receives from the gNB 200 an RRC Release message for causing the NCR-MT 520A to transition to the RRC idle state. Here, the RRC Release message includes a configuration value of a timer (also referred to as a “wake-up timer”) for determining the certain period of time. The NCR-MT 520A starts the timer upon having transitioned from the RRC connected state to the RRC idle state. When the timer expires (that is, a certain period of time elapses), the NCR-MT 520A initiates, to the network 5 (gNB 200), an RRC connection establishment procedure of transitioning to the RRC connected state.

In the RRC connection establishment procedure, the NCR-MT 520A transmits an RRC Setup Request message to the gNB 200. The RRC Setup Request message is also referred to as a message 3 (Msg3) in a random access procedure.

However, the gNB 200 may reject the RRC setup request from the NCR-MT 520A for reasons such as network congestion. At the time of receiving the RRC Setup Request message, the gNB 200 cannot distinguish whether the transmission source of the RRC Setup Request message is the UE 100 or the NCR-MT 520A, and thus, giving higher priority to the RRC Setup Request from the NCR-MT 520A is difficult.

In the first operation pattern, therefore, by using Cause (Establishment Cause) which is an information element included in the RRC Setup Request message, it is made possible for the gNB 200 to give higher priority to the RRC Setup Request from the NCR-MT 520A. The Cause is information indicating an establishment cause of the RRC connection. According to the technical specification of the 3GPP, any value among “emergency”, “highPriority Access”, “mt-Access”, “mo-Signalling”, “mo-Data”, “mo-VoiceCall”, “mo-VideoCall”, “mo-SMS”, “mps-Priority Access”, and “mcs-Priority Access” can be set to the Cause.

Among the values above, the “mt-Access” is a value indicating a response to paging as the establishment cause. In general, the “mt-Access” is set to have a priority higher than priorities of other establishment causes. Hence, the NCR-MT 520A sets the “mt-Access” as the Cause in the RRC Setup Request message transmitted in response to the expiration of the timer. This makes it possible for the gNB 200 to give higher priority to the RRC Setup Request from the NCR-MT 520A.

Note that the transition to the RRC connected state, accompanying the expiration of the timer configured by the gNB 200, can be considered as a concept close to calling from the gNB 200. Hence, although the NCR-MT 520A does not actually receive a paging message, by intentionally using the “mt-Access” as the Cause, the gNB 200 can preferentially accept the RRC Setup Request.

Note that a new Cause that is not defined in the current technical specification may be used instead of the “mt-Access”. The new Cause may be an “update of NCR configuration information”. The priority of such new Cause is preferably configured higher than those of other establishment causes. In the following, there will be described an example in which the “mt-Access” is used as the Cause.

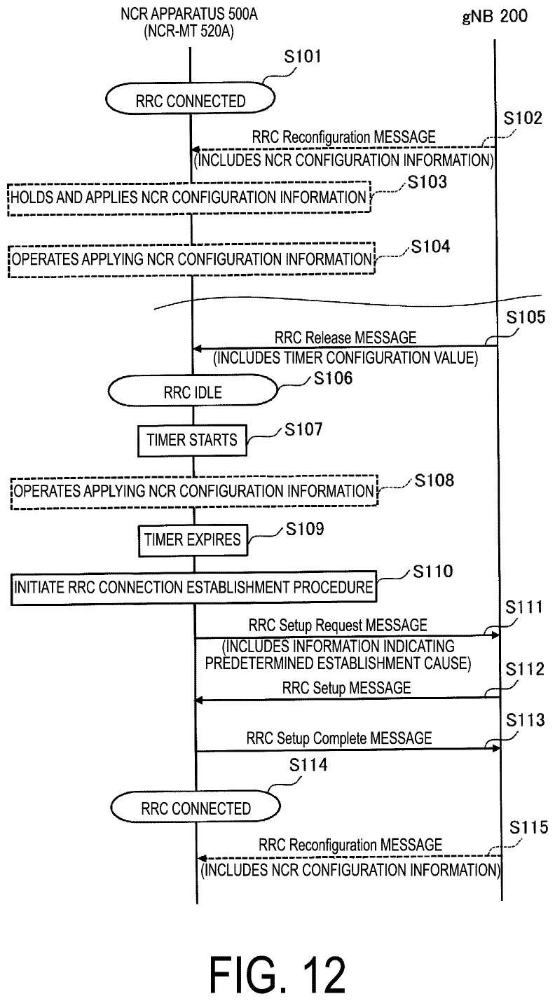

FIG. 12 is a diagram illustrating an example of the first operation pattern according to the first embodiment. In FIG. 12, non-essential steps are indicated by dashed lines.

In step S101, the NCR-MT 520A is in the RRC connected state in a cell of the gNB 200.

In step S102, the gNB 200 transmits an RRC Reconfiguration message including the NCR configuration information to be configured (added) in the NCR-MT 520A to the NCR-MT 520A. The NCR-MT 520A receives the RRC Reconfiguration message. The NCR configuration information may include information for configuring the NCR-Fwd 510A on.

In step S103, the NCR-MT 520A holds and applies the NCR configuration information of step S102.

In step S104, the NCR-MT 520A controls the NCR-Fwd 510A to perform an operation (relay operation) to which the NCR configuration information of step S102 is applied.

In step S105, the gNB 200 transmits the RRC Release message to the NCR-MT 520A. The RRC Release message includes a timer configuration value. The NCR-MT 520A receives the RRC Release message. The AS of the NCR-MT 520A may notify the timer configuration value to the NAS of the NCR-MT 520A. In this case, the NAS of the NCR-MT 520A manages the timer. Note that in the following, the AS of the NCR-MT 520A is assumed to manage the timer.

In step S106, the NCR-MT 520A transitions to the RRC idle state in response to receiving the RRC Release message. Here, the NCR-MT 520A may maintain the held NCR configuration information without discarding the held NCR configuration information in response to the timer configuration value being included in the RRC Release message.

In step S107, the NCR-MT 520A starts the timer to which the above-described timer configuration value is applied in response to transitioning to the RRC idle state (reception of the RRC Release message).

In step S108, the NCR-MT 520A controls the NCR-Fwd 510A, while the timer is running, to perform an operation (relay operation) to which the held NCR configuration information is applied. Note that in the first operation pattern, for example, when the OAM client of the NCR-MT 520A generates uplink data, the NCR-MT 520A may initiate the RRC connection establishment procedure even while the timer is running. Although details will be described below, in a second operation pattern, disallowed is the initiation of the RRC connection establishment procedure while the timer is running.

In step S109, the NCR-MT 520A detects the expiration of the timer. The NCR-MT 520A may discard the held NCR configuration information in response to the expiration of the timer.

In step S110, the NCR-MT 520A initiates the RRC connection establishment procedure in response to the expiration of the timer. Here, the NCR-MT 520A generates an RRC Setup Request message in which the “mt-Access” is set as the Cause. The AS of the NCR-MT 520A may autonomously set the “mt-Access” as the Cause in response to the expiration of the timer. For example, the AS of the NCR-MT 520A may generate an RRC Setup Request message in which the “mt-Access” is set as the Cause, regardless of the Cause notified by the NAS of the NCR-MT 520A. That is, the AS of the NCR-MT 520A may replace the Cause notified by the NAS of the NCR-MT 520A with the “mt-Access”.

The NAS of the NCR-MT 520A may designate the AS of the NCR-MT 520A to set the “mt-Access” as the Cause. For example, first, the AS of the NCR-MT 520A notifies the NAS of the NCR-MT 520A that the timer has expired or that access (Access Type) as an NCR apparatus is required. The AS of the NCR-MT 520A may notify the NAS of the NCR-MT 520A of the UE-ID (5G-S-TMSI) of the NCR-MT 520A. This is the same operation as that at the time of paging reception, but the operation is applied not at the time of paging reception but at the time of timer expiration. This can prompt the Cause to be set to the “mt-Access” without affecting the NAS specification. Second, the NAS of the NCR-MT 520A requests the RRC connection establishment to the AS of the NCR-MT 520A. Here, the NAS of the NCR-MT 520A notifies the AS of the NCR-MT 520A of the “mt-Access” as the Cause in response to the notification from the AS of the NCR-MT 520A. Third, the AS of the NCR-MT 520A generates an RRC Setup Request message in which the Cause notified by the NAS of the NCR-MT 520A is set.

In step S111, the NCR-MT 520A transmits the RRC Setup Request message generated in step S110 to the gNB 200. The gNB 200 receives the RRC Setup Request message.

In step S112, the gNB 200 preferentially accepts a connection request based on the Cause in the RRC Setup Request message of step S111, and transmits the RRC Setup message to the NCR-MT 520A. The NCR-MT 520A receives the RRC Setup message.

In step S113, the NCR-MT 520A transmits the RRC Setup Complete to the gNB 200. The gNB 200 receives the RRC Setup Complete message. The RRC Setup Complete message may include an indicator indicating that the transmission source of the message is the NCR apparatus 500A (NCR-MT 520A). The gNB 200 can recognize based on the indicator that the apparatus accessing the gNB 200 itself is not the UE 100 but the NCR apparatus 500A (NCR-MT 520A).

In step S114, the NCR-MT 520A transitions to the RRC connected state.

In step S115, the gNB 200 transmits the RRC Reconfiguration message including new NCR configuration information to the NCR-MT 520A. The NCR-MT 520A receives the RRC Reconfiguration message.

### (1.4.2) Second Operation Pattern

The second operation pattern according to the first embodiment will be described, focusing mainly on differences from the above-described first operation pattern. The second operation pattern may be performed in combination with the above-described first operation pattern.

As described above, in the first operation pattern, for example, when the OAM client of the NCR-MT 520A generates uplink data, the NCR-MT 520A may initiate the RRC connection establishment procedure even while the timer is running. However, such operation may occur immediately after the gNB 200 causes the NCR-MT 520A to transition to the RRC idle state, and there is a concern that a ping-pong phenomenon of the RRC state transition may occur.

Hence, in the second operation pattern, the above-described timer is used as a “prohibit timer”, that is, a timer for determining disallowing time for disallowing the transition to the RRC connected state. The NCR-MT 520A controls so as not to initiate the RRC connection establishment procedure (disallows the RRC connection establishment procedure) while the timer is running. This makes it possible to suppress the occurrence of the above-described ping-pong phenomenon.

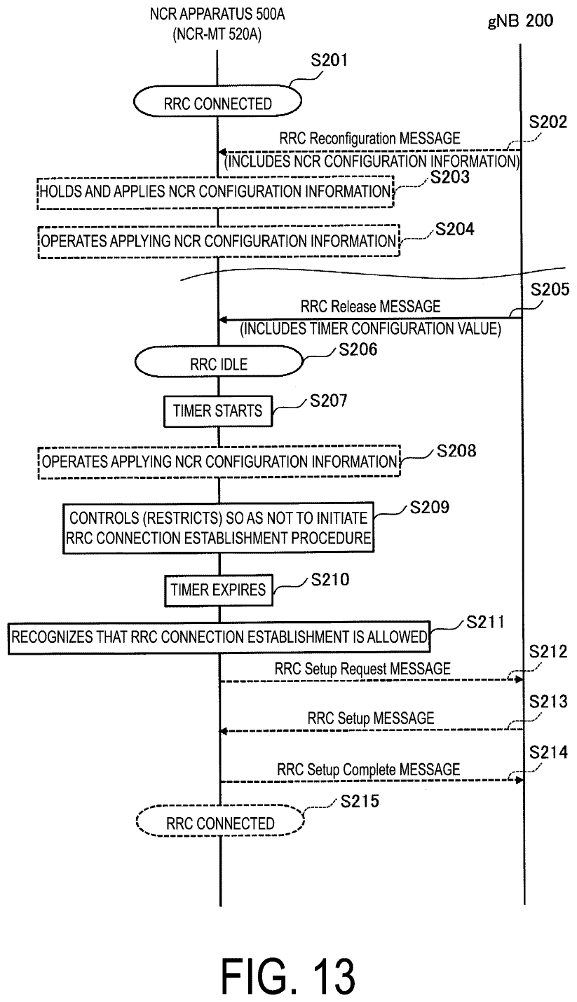

FIG. 13 is a diagram illustrating an example of the second operation pattern according to the first embodiment. In FIG. 13, dashed lines indicate non-essential steps. With the operations the same and/or similar to the above-described first operation pattern, redundant description will be omitted.

The operations in step S201 to step S207 are the same as those of the first operation pattern described above.

In step S207, the NCR-MT 520A starts the timer in response to transitioning to the RRC idle state. The NCR-MT 520A may control the NCR-Fwd 510A, while the timer is running, to perform an operation (relay operation) to which the held NCR configuration information is applied (step S208).

In step S209, the NCR-MT 520A controls (restricts) so as not to initiate the RRC connection establishment procedure while the timer is running. The NCR-MT 520A may suspend the initiation of the RRC connection establishment procedure until the timer expires.

For example, the AS of the NCR-MT 520A may ignore or suspend the connection establishment request from the upper layer (NAS of the NCR-MT 520A or the OAM client). The AS of the NCR-MT 520A may notify the upper layer that the timer for disallowing the RRC connection establishment is running (that is, the connection establishment is disallowed). At this time, the AS of the NCR-MT 520A may notify the upper layer of the remaining value of the timer (the remaining time until the timer expires). The upper layer of the NCR-MT 520A may perform processing such as stopping (suspending) the timer for monitoring the RRC connection establishment procedure in response to the notification from the AS of the NCR-MT 520A.

In step S210, the NCR-MT 520A detects the expiration of the timer.

In step S211, the NCR-MT 520A recognizes that the initiation of the RRC connection establishment procedure is allowed in response to the expiration of the timer. The NCR-MT 520A may perform the initiation of the RRC connection establishment procedure that has been suspended, in response to the expiration of the timer (step S211 to step S215). The AS of the NCR-MT 520A may notify the upper layer that the timer has expired or that the connection establishment has become an allowed state.

### (1.4.3) Third Operation Pattern

The third operation pattern according to the first embodiment will be described, focusing mainly on differences from the above-described operation pattern. The third operation pattern is an operation pattern based on the second operation pattern. The third operation pattern below will be described, focusing mainly on differences from the second operation pattern.

In the second operation pattern, while the timer (prohibit timer) is running, the NCR-MT 520A restricts so as not to initiate the RRC connection establishment procedure regardless of the cause (reason) of performing the RRC connection establishment. However, not performing the RRC connection establishment may make the network 5 be unable to communicate with the NCR-MT 520A (NCR apparatus 500A). In particular, the inability to access the NCR apparatus 500A from the OAM server can be a problem. For example, with the OAM server generating a DL traffic, the NCR-MT 520A receives a paging message. Here, even when the NAS of the NCR-MT 520A makes an RRC connection request, if the AS of the NCR-MT 520A does not perform an RRC connection establishment, the OAM server enters a state in which communication with the NCR apparatus 500A is not possible. This means that the operator cannot access the NCR apparatus 500A that has already been installed, presenting a problem in network management.

In the third operation pattern, therefore, such problem is made solvable by making it possible to provide selectivity such that the RRC connection establishment by the UL traffic may not be performed but the RRC connection establishment by the DL traffic may be performed.

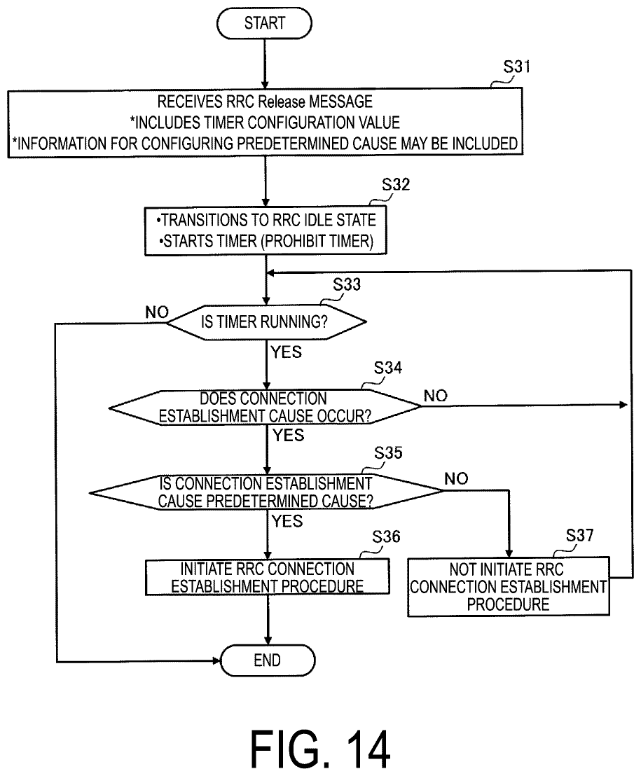

FIG. 14 is a diagram illustrating an operation example of the NCR-MT 520A according to the third operation pattern.

In step S31, the NCR-MT 520A in the RRC connected state receives an RRC Release message from the gNB 200. In the third operation pattern, the RRC Release message includes a timer configuration value for designating a time length of a timer (prohibit timer). The RRC Release message may include information for configuring a “predetermined cause” to be described below. The predetermined cause is a connection establishment cause in which the initiation of the RRC connection establishment procedure is allowed even while the timer is running. The predetermined cause is also a connection establishment cause that can ignore the timer.

In step S32, the NCR-MT 520A transitions from the RRC connected state to the RRC idle state in response to receiving the RRC Release message. When having transitioned from the RRC connected state to the RRC idle state, the NCR-MT 520A starts a timer (prohibit timer) for restricting the initiation of the RRC connection establishment procedure of the RRC connection establishment to transition to the RRC connected state. The timer configuration value received in step S31 is set to the timer.

In step S33, the NCR-MT 520A in the RRC idle state checks whether or not the timer is running. When the timer is running (step S33: YES), the processing proceeds to step S34.

In step S34, the NCR-MT 520A in the RRC idle state checks whether or not a cause of performing the RRC connection establishment has occurred.

When a cause of performing the RRC connection establishment occurs (step S34: YES), in step S35, the NCR-MT 520A in the RRC idle state checks whether or not the cause of performing the RRC connection establishment is the predetermined cause.

When the cause of performing the RRC connection establishment is the predetermined cause (step S35: YES), in step S36, the NCR-MT 520A in the RRC idle state initiates the RRC connection establishment procedure even while the timer is running. In this case, the NCR-MT 520A may stop the timer. With the RRC connection establishment procedure, the NCR-MT 520A transitions from the RRC idle state to the RRC connected state.

On the other hand, when the cause of performing the RRC connection establishment is not the predetermined cause (step S35: NO), the NCR-MT 520A in the RRC idle state does not initiate the RRC connection establishment procedure.

Thus, when having transitioned from the RRC connected state to the RRC idle state, the NCR-MT 520A starts the timer for restricting the initiation of the RRC connection establishment procedure of transitioning to the RRC connected state. The NCR-MT 520A restricts, while the timer is running, not to initiate the RRC connection establishment procedure in response to the cause of performing the RRC connection establishment not being the predetermined cause. The NCR-MT 520A initiates, while the timer is running, the RRC connection establishment procedure in response to the cause of performing the RRC connection establishment being the predetermined cause. This makes it possible to provide selectivity such that the RRC connection establishment by the UL traffic may not be performed but the RRC connection establishment by the DL traffic may be performed.

The predetermined cause may be defined in the technical specification in advance. The predetermined cause defined in advance includes the occurrence of an incoming call from the network 5 to the NCR-MT 520A (also referred to as “Mobile Terminated (MT)-access”). This makes it possible for the NCR-MT 520A to initiate the RRC connection establishment procedure and transition to the RRC connected state, even while the timer (prohibit timer) is running, when there is an incoming call (that is, paging reception) from the network 5. Thus, it becomes easy to access the NCR apparatus 500A in the RRC idle state from the OAM server, for example.

The predetermined cause may further include the occurrence of signaling (also referred to as “Mobile Originated (MO)-signaling”) transmitted from the NCR-MT 520A to the network 5. The signaling is the NAS signaling, and may include, for example, a Tracking Area Update message. Note that the OAM traffic generated by the OAM client in the NCR-MT 520A is classified as user-data and is MO-data rather than MO-signaling. The NCR-MT 520A restricts (disallows) the RRC connection establishment by such MO-data while the timer is running.

The predetermined cause may be configurable for the NCR-MT 520A from the network 5 (gNB 200). In this case, the NCR-MT 520A receives configuration information for designating the predetermined cause from the gNB 200.

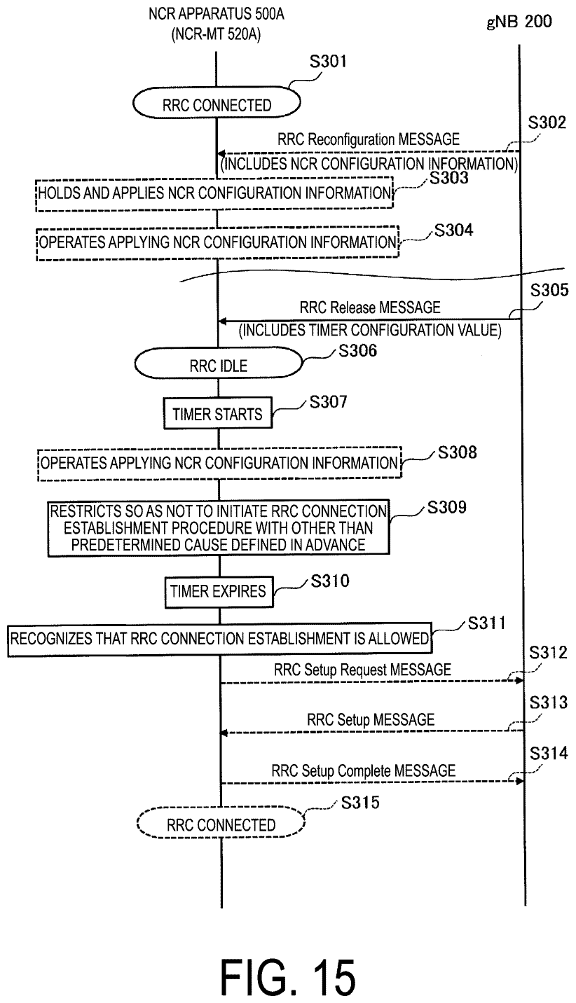

FIG. 15 is a diagram illustrating an example of an operation of the mobile communication system 1 according to the third operation pattern.

The operations in step S301 to step S308 are the same as those of the second operation pattern described above (see FIG. 13). Specifically, the gNB 200 transmits an RRC Release message including a timer configuration value to the NCR-MT 520A (step S305). In the NCR-MT 520A that has received the RRC Release message, the AS (for example, the RRC layer) may notify the upper layer (the NAS or the OAM client) of the timer configuration value, and the upper layer may manage the timer. In the following, described is an example in which the AS of the NCR-MT 520A manages the timer. The NCR-MT 520A transitions to the RRC idle state and starts the timer (step S306 and step S307).

In step S309, while the timer is running, the NCR-MT 520A in the RRC idle state may restrict the initiation of the RRC connection establishment procedure due to the UL traffic. The restriction may be disallowing the initiation of the RRC connection establishment procedure. The restriction may be suspending the initiation of the RRC connection establishment procedure.

The AS (for example, the RRC layer) of the NCR-MT 520A in the RRC idle state may perform, while the timer is running, any of the following pieces of processing a) to c) in response to a connection establishment request from the upper layer (the NAS or the OAM client).
a) When a connection establishment request from the NAS to the AS of the NCR-MT 520A is present, and a connection establishment cause (cause, also referred to as NAS provision cause value) notified from the NAS to the AS at the time of the connection establishment request is the MT-access, the AS of the NCR-MT 520A initiates the RRC connection establishment procedure. The AS of the NCR-MT 520A may initiate the RRC connection establishment procedure also when a connection establishment request from the NAS to the AS is present and the connection establishment cause (cause) notified from the NAS to the AS at the time of the connection establishment request is the MO-signalling. On the other hand, the AS of the NCR-MT 520A does not initiate the RRC connection establishment procedure when the connection establishment cause (cause) is the MO-data, for example. Note that, when having initiated the RRC connection establishment, the NCR-MT 520A may stop (terminate) the timer upon transmitting/having transmitted the RRC Setup Request message, for example.
b) When a connection establishment request from the NAS to the AS of the NCR-MT 520A is present and the connection establishment cause (cause) notified from the NAS to the AS at the time of the connection establishment request is not the MT-access (and/or the MO-signalling) (for example, in the case of MO-data), the connection establishment request is ignored or suspended.
c) The AS of the NCR-MT 520A notifies the upper layer of the NCR-MT 520A of at least one of the following: the timer (prohibit timer) is running, the occurrence of the UL traffic is disallowed (restricted), the connection establishment by the UL traffic is being disallowed, the remaining value of the timer (how many minutes it will take to expire), the connection establishment request from the NAS to the AS is ignored, the connection establishment request from the NAS to the AS is being suspended, and the UL data accompanying the connection establishment request is being suspended (or not transmitted (waiting for transmission)). By the notification, the upper layer (the NAS or the OAM client) may perform processing such as stopping (suspending) the monitoring timer of the RRC connection establishment procedure. The upper layer may regulate (suppress) the occurrence of the UL traffic.

In step S310, it is assumed that the timer expires without performing the RRC connection establishment procedure. In this case, the NCR-MT 520A in the RRC idle state recognizes, when the timer expires, that the initiation of the RRC connection establishment procedure is allowed (step S311). When the timer expires, the NCR-MT 520A in the RRC idle state may initiate the suspended RRC connection establishment procedure. Further, when the timer expires, the NCR-MT 520A in the RRC idle state may notify the upper layer that the timer has expired and/or that the connection establishment has become an allowed state. The AS of the NCR-MT 520A may notify the upper layer of either having executed the suspended connection establishment request from the NAS to the AS or having transmitted the suspended UL data.

The operations from step S312 to step S315 are the same as those of the second operation pattern (see FIG. 13) described above.

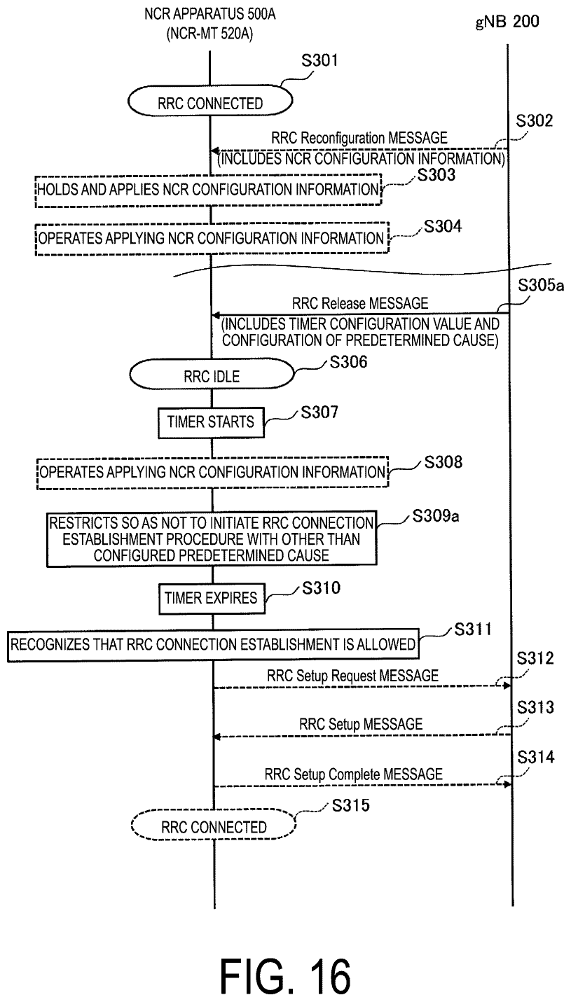

FIG. 16 is a diagram illustrating another example of an operation of the mobile communication system 1 according to the third operation pattern. Here, the difference from the operation of FIG. 15 will be described. In the operation example of FIG. 16, the predetermined cause can variably be configured. For example, the gNB 200 configures whether the prohibit timer is applied to all the traffic or only to the UL traffic, or the like for the NCR-MT 520A.

In step S305a, the gNB 200 transmits the RRC Release message including a timer configuration value to the NCR-MT 520A. In this operation example, the RRC Release message includes information on the application condition of the timer (prohibit timer). The information is also information for configuring the RRC connection establishment cause to which the timer (prohibit timer) is not applied.

The information may be information for designating a traffic type to which the timer (prohibit timer) is applied/not applied. For example, the information may be at least one of the following: the timer (prohibit timer) is applied to all the traffic, applied only to the UL traffic, applied only to the DL traffic, applied excluding the DL traffic, and applied excluding the UL traffic.

The information may be information for designating a NAS provision cause value to which the timer (prohibit timer) is applied/not applied. For example, the information may be at least one of: applied excluding a case of the MT-access, applied excluding a case of the MO-signalling, and applied in a case of the MO-data.

In step S309a, the NCR-MT 520A in the RRC idle state restricts, while the timer (prohibit timer) is running, the RRC connection establishment in accordance with the information configured in step S305a.

### (1.4.4) Fourth Operation Pattern

The fourth operation pattern of the first embodiment will be described, focusing mainly on differences from the above-described operation pattern. The fourth operation pattern is an operation pattern based on a combination of the first operation pattern and the second operation pattern (may be the third operation pattern) described above.

The timer according to the first operation pattern is a wake-up timer for initiating the RRC connection establishment procedure when the timer expires. The timer according to the second operation pattern and the third operation pattern is a prohibit timer for restricting the initiation of the RRC connection establishment procedure while the timer is running. On the other hand, in the fourth operation pattern, one timer may be provided with both functions of the wake-up timer and the prohibit timer. This enables an efficient operation compared to a case where the wake-up timer and the prohibit timer are separately configured/managed.

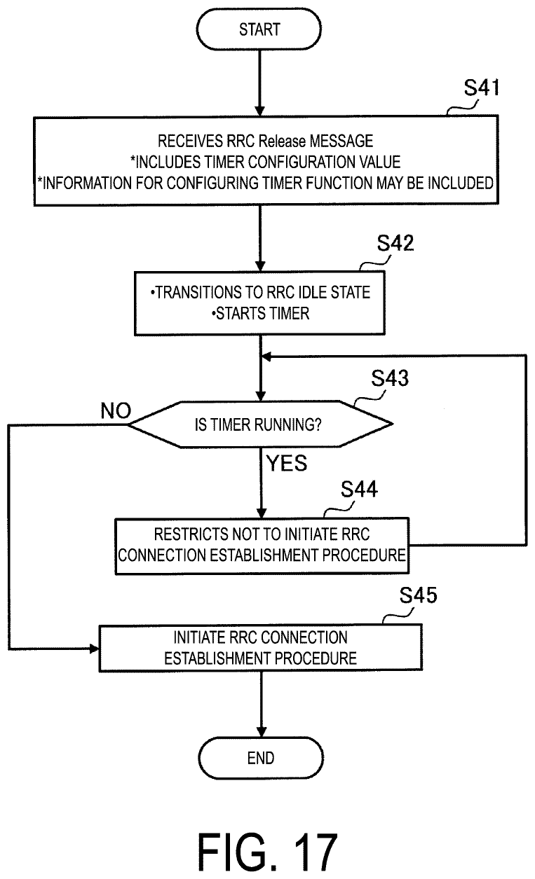

FIG. 17 is a diagram illustrating an operation example of the NCR-MT 520A according to the fourth operation pattern.

In step S41, the NCR-MT 520A in the RRC connected state receives the RRC Release message from the gNB 200. In the fourth operation pattern, the RRC Release message includes a timer configuration value designating the time length of the timer. The RRC Release message may include information for configuring the function of the timer (“wake-up timer”, “prohibit timer”, or “both”). Here, it is assumed that the function of the timer is “both”.

In step S42, the NCR-MT 520A transitions from the RRC connected state to the RRC idle state in response to receiving the RRC Release message. The NCR-MT 520A starts the timer upon transitioning from the RRC connected state to the RRC idle state. The timer configuration value received in step S41 is set to the timer.

In step S43, the NCR-MT 520A in the RRC idle state checks whether or not the timer is running. When the timer is running (step S43: YES), in step S44, the NCR-MT 520A in the RRC idle state restricts so as not to initiate the RRC connection procedure. Note that the NCR-MT 520A in the RRC idle state, the same as in the third operation pattern, may be allowed to initiate the RRC connection procedure only when the RRC connection establishment cause is the predetermined cause.

When the timer expires (step S43: NO), in step S44, the NCR-MT 520A in the RRC idle state initiates the RRC connection procedure and transitions to the RRC connected state.

In the fourth operation pattern, the NCR-MT 520A starts the timer upon transitioning from the RRC connected state to the RRC idle state. The NCR-MT 520A in the RRC idle state restricts so as not to initiate the RRC connection establishment procedure while the timer is running and initiates the RRC connection establishment procedure when the timer expires.

In the fourth operation pattern, when receiving information to configure restricting the initiation of the RRC connection establishment procedure while the timer is running (that is, information for designating “prohibit timer” or “both” as the function of the timer) from the gNB 200, the NCR-MT 520A may treat the timer as the prohibit timer and restrict the initiation of the RRC connection establishment procedure while the timer is running.

In the fourth operation pattern, when receiving information to configure initiating the RRC connection establishment procedure when the timer expires (that is, information for designating “wake-up timer” or “both” as the function of the timer) from the gNB 200, the NCR-MT 520A may treat the timer as the wake-up timer and initiate the RRC connection establishment procedure when the timer expires.

### (2) Second Embodiment

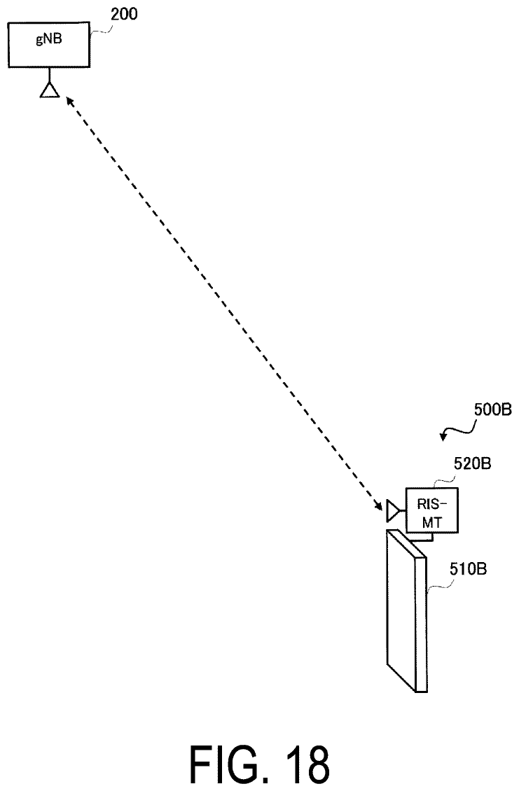

Next, a second embodiment will be described, focusing mainly on differences from the above-described embodiments. As illustrated in FIG. 18, a relay apparatus according to the second embodiment is a Reconfigurable Intelligent Surface (RIS) apparatus 500B that changes a propagation direction of an incident radio wave (radio signal) through reflection or refraction. The “NCR” in the above-described embodiments may be read as the “RIS”.

The RIS is a type of a relay device (hereinafter, also referred to as a “RIS-Fwd”) capable of performing beamforming (directivity control) in a similar way to the NCR by changing the characteristics of metamaterials. The RIS may be able to change a range (distance) of a beam by controlling a reflection direction and/or a refraction direction of each unit element. For example, the RIS may have a configuration capable of controlling the reflection direction and/or refraction direction of each unit element, and focusing on a near UE (directing a beam) or focusing on a far UE (directing a beam).

The RIS apparatus 500B includes a new UE (hereinafter referred to as “RIS-MT”) 520B that is a control terminal for controlling RIS-Fwd 510B. The RIS-MT 520B controls the RIS-Fwd 510B in cooperation with the gNB 200 by establishing a wireless connection to the gNB 200 and performing wireless communication with the gNB 200. The RIS-Fwd 510B may be a reflective RIS. Such an RIS-Fwd 510B reflects an incident radio wave to change a propagation direction of the radio wave. Here, a reflection angle of the radio wave can be variably set. The RIS-Fwd 510B reflects radio waves incident from the gNB 200 toward the UE 100. The RIS-Fwd 510B may be a transmissive RIS. Such an RIS-Fwd 510B refracts an incident radio wave to change the propagation direction of the radio wave. Here, a refraction angle of the radio wave can be variably set.

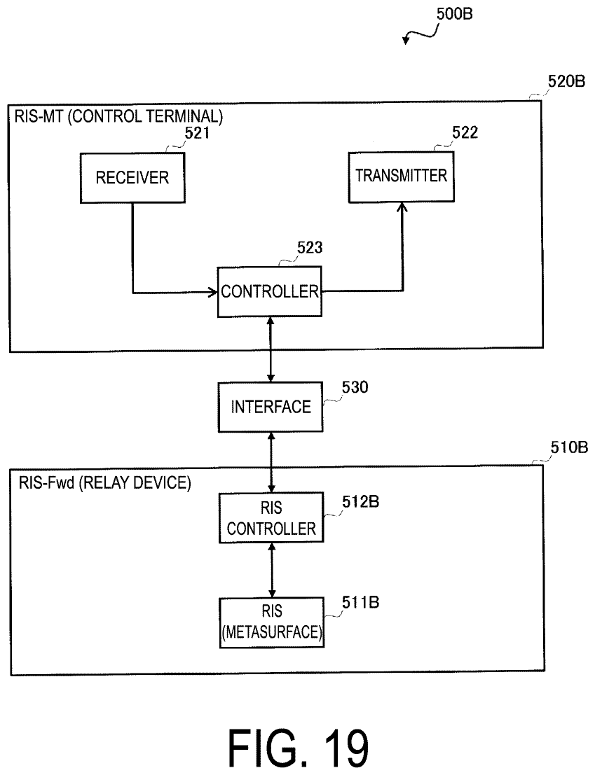

FIG. 19 is a diagram illustrating a configuration example of an RIS-Fwd (relay device) 510B and an RIS-MT (control terminal) 520B according to the second embodiment. The RIS-MT 520B has a receiver 521, a transmitter 522, and a controller 523. Such a configuration is the same as that of the above-described embodiment. The RIS-Fwd 510B includes an RIS 511B and an RIS controller 512B. The RIS 511B is a metasurface configured using a metamaterial. For example, RIS 511B is configured by disposing extremely small structures relative to the wavelength of radio waves in an array, and the direction and/or beam shape of the reflected waves can be arbitrarily designed by making the structures different shapes depending on their disposition location. The RIS 511B may be a transparent dynamic metasurface. The RIS 511B may be configured by stacking a transparent glass substrate on transparent version of a metasurface substrate on which a large number of small structures are regularly disposed, and may be capable of dynamically controlling three patterns of a mode of transmitting an incident radio wave, a mode of transmitting a part of a radio wave and reflecting a part thereof, and a mode of reflecting all radio waves by minutely moving the stacked glass substrate. The RIS controller 512B controls the RIS 511B in response to an RIS control signal from the controller 523 in the RIS-MT 520B. The RIS controller 512B may include at least one processor and at least one actuator. The processor interprets an RIS control signal from the controller 523 in the RIS-MT 520B to drive the actuator in response to the RIS control signal.

### (3) Other Embodiments

In the above-described embodiment, an example in which the RRC state of the NCR-MT 520A is idle has been described. However, the RRC state of the NCR-MT 520A may be inactive. In this case, the NCR-MT 520A uses the RRC connection resume procedure instead of the RRC connection establishment procedure in order to transition to the RRC connected state.

In the above-described embodiment, an example in which the relay apparatus performing relay transmission is the NCR apparatus 500A or an RIS apparatus 500B has been described. However, the relay apparatus that performs relay transmission is not limited to the NCR apparatus 500A or the RIS apparatus 500B, and may be an Integrated Access and Backhaul (IAB) node defined in the technical specifications of 3GPP.

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

In the above-described embodiment, an example in which the base station is an NR base station (gNB) has been described, but the base station may be an LTE base station (eNB). The base station may be a relay node such as an IAB node. The base station may be a Distributed Unit (DU) of the IAB node. The UE 100 may be a Mobile Termination (MT) of the IAB node.

That is, the UE 100 may be a terminal function unit (a type of communication module) for a base station to control a relay device that performs signal relay. Such terminal function unit is referred to as an MT. Examples of the MT include, a Network Controlled Repeater (NCR)-MT, a Reconfigurable Intelligent Surface (RIS)-MT, in addition to the IAB-MT.

The term “network node” mainly means a base station, but may also mean a core network apparatus or a part (CU, DU, or RU) of the base station. The network node may include a combination of at least a part of the apparatus of the core network and at least a part of the base station.

A program causing a computer to execute each of the processes performed by the communication apparatus according to the embodiment described above, for example, the UE 100 (NCR-MT 520A and RIS-MT 520B) or the gNB 200 may be provided. The program may be recorded on a computer-readable medium. The computer-readable medium allows the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 and the gNB 200 may be implemented as a semiconductor integrated circuit (chipset, System on a chip (SoC)).

The functions realized by the UE 100 or the gNB 200 (network node) may be implemented in circuitry or processing circuitry including general-purpose processors, special-purpose processors, integrated circuits, Application Specific Integrated Circuits (ASICs), Central Processing Units (CPUs), conventional circuits, and/or combinations thereof which are programmed to perform the described functionality. The processor includes a transistor and other circuits, and is considered as circuitry or processing circuitry. The processor may be a programmed processor that executes a program stored in a memory. In the present description, circuitry, units, means are hardware programmed to achieve or hardware to execute the described functions. The hardware may be any hardware disclosed in the present description, any hardware programmed to achieve or known to execute the described functions. When the hardware is a processor considered to be a type of circuitry, the circuitry, means, or units are a combination of hardware and software used to configure the hardware and/or processor.

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### (4) Supplementary Note A

Features relating to the embodiments described above will be described below as supplements.

### Supplementary Note 1

A communication method executed by a relay apparatus including a relay device configured to perform a relay operation of relaying a radio signal transmitted between a network node and a user equipment and a control terminal configured to receive a control signal used for control of the relay device from the network node, the communication method including:
starting, by the control terminal, a timer restricting the initiation of a radio resource control (RRC) connection establishment procedure of transitioning to an RRC connected state upon having transitioned from the RRC connected state to an RRC idle state;
restricting so as not to initiate the procedure, while the timer is running, in response to a cause of performing the RRC connection establishment not being a predetermined cause; and
initiating the procedure, while the timer is running, in response to the cause of performing the RRC connection establishment being the predetermined cause.

### Supplementary Note 2

The communication method according to Supplementary Note 1, in which
the predetermined cause is an occurrence of an incoming call from a network to the control terminal.

### Supplementary Note 3

The communication method according to Supplementary Note 1, in which
the predetermined cause is an occurrence of signaling transmitted from the control terminal to a network.

### Supplementary Note 4

The communication method according to any of Supplementary Notes 1 to 3, further including:
receiving, by the control terminal, configuration information designating the predetermined cause from the network node.

### Supplementary Note 5

The communication method according to any of Supplementary Notes 1 to 4, further including:
receiving, from the network node, an RRC Release message configured to cause the control terminal to transition to the RRC idle state, in which the RRC Release message includes a timer configuration value designating a time length of the timer.

### Supplementary Note 6

A relay apparatus including:
a relay device configured to perform a relay operation of relaying a radio signal transmitted between a network node and a user equipment; and
a control terminal configured to receive a control signal used for control of the relay device from the network node,
in which the control terminal:
starts a timer restricting initiation of a radio resource control (RRC) connection establishment procedure of transitioning to an RRC connected state upon having transitioned from the RRC connected state to an RRC idle state;
restricts so as not to initiate the procedure, while the timer is running, in response to a cause of performing the RRC connection establishment not being a predetermined cause; and
initiates the procedure, while the timer is running, in response to the cause of performing the RRC connection establishment being the predetermined cause.

### Supplementary Note 7

A communication method executed by a relay apparatus including a relay device configured to perform a relay operation of relaying a radio signal transmitted between a network node and a user equipment and a control terminal configured to receive a control signal used for control of the relay device from the network node, the communication method including:
starting a timer, by the control terminal, upon having transitioned from a radio resource control (RRC) connected state to an RRC idle state;
restricting initiation of an RRC connection establishment procedure of transitioning to the RRC connected state while the timer is running; and
initiating the procedure when the timer expires.

### Supplementary Note 8

The communication method according to Supplementary Note 7, further including:
receiving, by the control terminal, while the timer is running, information to configure restricting the initiation of the procedure from the network node,
in which the restricting includes restricting the initiation of the procedure while the timer is running, when restricting the initiation of the procedure while the timer is running is configured.

### Supplementary Note 9

The communication method according to Supplementary Note 7 or 8, further including:
receiving, by the control terminal, information to configure initiating the procedure when the timer expires from the network node,
in which the initiating includes initiating the procedure when the timer expires, when initiating the procedure when the timer expires is configured.

### Supplementary Note 10

A relay apparatus including:
a relay device configured to perform a relay operation of relaying a radio signal transmitted between a network node and a user equipment; and
a control terminal configured to receive a control signal used for control of the relay device from the network node,
in which the control terminal includes:
starting a timer when the control terminal has transitioned from a radio resource control (RRC) connected state to an RRC idle state;
restricting, while the timer is running, initiation of an RRC connection establishment procedure of transitioning to the RRC connected state; and
initiating the procedure when the timer expires.

### (5) Supplementary Note B

Features relating to the embodiments described above will be described as supplements.

The gNB 200 may intentionally cause the NCR-MT 520A to transition to the RRC idle state for reasons such as power saving of the NCR apparatus 500A and/or congestion in network 5. However, since RAN paging cannot be used for the NCR-MT 520A in the RRC idle state, the gNB 200 has no way to cause the NCR-MT 520A to transition to the RRC connected state, thereby making the NCR-MT 520A unreachable. Hence, when released to the RRC idle state, the NCR apparatus 500A is no longer a network controlled repeater (for example, considered similar to a legacy RF repeater). Thus, if the gNB 200 intentionally releases the NCR-MT 520A to the RRC idle state, for example, for power saving, congestion in network 5, or the like, the gNB 200 cannot page the NCR-MT 520A in the RRC idle state.

It is considered that the OAM server on the network 5 may be used to page the NCR-MT 520A in the RRC idle state. That is, the OAM server generates DL OAM traffic (that is, U-plane data) that triggers the AMF 300A to initiate CN paging to the NCR-MT 520A. However, it is unclear how the OAM server recognizes that the NCR-MT 520A is in the RRC idle state. This is because, when the gNB 200 releases the NCR-MT 520A, it is assumed that when receiving the RRC Release message, the NCR-MT 520A has no way to transmit UL OAM traffic, for example, U-plane data such as data indicating having been released to the RRC idle state. Thus, since the NCR-MT 520A has no way to transmit the UL OAM traffic after being released by the gNB 200, the OAM does not recognize whether or not the NCR-MT 520A is in the RRC idle state.

Further, it may be a problem for the gNB 200 to intentionally release the NCR-MT 520A for some purpose, even though the OAM server is forcing the NCR-MT 520A back to the RRC connected state. In order to solve these problems, it is required to assume that some coordination is required between gNB-OAM and NCR-OAM. However, this results in increase of the workload of the operator or loss of multi-vendor interoperability.

Thus, the DL OAM traffic may be an option to trigger the AMF 300A to page the NCR-MT 520A in the RRC idle state, but this requires coordination between the gNB-OAM and the NCR-OAM, which may lead to lowering the operation efficiency of the network 5.

Another implementation option is to use the OAM client in the NCR-MT 520A. The OAM client can determine the transition of the NCR-MT 520A to the RRC idle state by using not only the release status of the NCR-MT 520A, but also its failure conditions (RLF, RRC resume failure, or the like) and the initial access conditions (power on or the like). In a case of the failure and the initial access, the OAM client may generate the UL OAM traffic (that is, the U-plane data) for connecting with the OAM server, for example. The UL packet triggers the RRC connection establishment procedure. Note that, in the case of the RRC release, a “ping-pong” RRC state transition may occur. That is, since being automatic processing in the case of the NCR-MT 520A in the RRC idle state, the NCR-MT 520A may initiate the RRC connection establishment immediately after being released by the gNB 200.

As described above, use of the UL OAM traffic may be another option to trigger the NCR-MT 520A to initiate the RRC connection establishment, but this may occur immediately after the gNB 200 releases the NCR-MT 520A to the RRC idle state.

According to the above observations, because an OAM-based solution may cause another problem, the implementation alone does not work properly. On the other hand, it is clear that the advantage of the OAM-based solution is not impacting the specification. The advantage of the OAM-based solution is not impacting the specification.

On the other hand, a wake-up timer has been proposed to trigger the NCR-MT 520A to return to the RRC connected state. The idea is that the NCR-MT 520A starts a timer (when configured with the RRC Release message) and when the timer expires, the NCR-MT 520A initiates the RRC connection establishment procedure. This solution allows for fixing the above mentioned problems (in particular, when the OAM server does not implement automatic generation of the DL traffic such as keep-alive message) and enables the gNB 200 to control the NCR-MT 520A in the RRC idle state.

With respect to the keep-alive message as the OAM-based solution, a significant amount of wasted messages is required, in particular in a case of a rare event that the gNB 200 releases the NCR-MT 520A to the RRC idle state, which depends on the implementation of the gNB 200. In particular, when the OAM server does not implement so-called keep-alive messaging and the RRC connection control is entirely under the control of the gNB 200, the wake-up timer can solve the above-mentioned problem.

One approach of the wake-up timer is an AS-based approach. When the wake-up timer expires, the AS may act as having received a paging message. That is, the AS indicates the UE-ID (that is, ue-Identity) to the NAS. Because the NAS can also operate as if the access attempt is an MT access (that is, Access Identity 0 and Access Category 0 for “MT_acc”), the AS can configure the establishment cause by the MT access following the access attempt of the NAS. This establishment cause (that is, MT access) is still considered consistent with the current definition, because the expiration of the wake-up timer may mean that the network 5 (that is, the gNB 200) calls back the NCR-MT 520A to the RRC connected state. This solution is expected to have less impact on the NAS specification, but the AS specification needs to be slightly modified in the operation when the timer expires.

Another approach for the wake-up timer is a NAS-based approach. When the wake-up timer expires, the AS notifies the NAS, and the NAS requests establishment of a signaling connection. Since this is considered as a new definition of the access attempt, the impact on the AS specification, by the new operation in the NAS specification when the timer expires, is small. As another option, it is conceivable that the wake-up timer value may be transferred when the AS is configured by the RRC Release message. The NAS handles the timer and requests establishment of a signaling connection when the timer expires. This solution requires the timer handling to be specified in the NAS specification, in addition to the new definition of the above-described access attempt. Hence, in addition to the new operation of the AS specification, the largest impact on the NAS specification is observed with this option.

In view of the above analysis, it can be concluded that the timer is to be handled by the AS in order to minimize the potential impact on the NAS. In addition, the AS-based approach may be slightly preferred because the impact on other layers is minimized (or possibly avoided). In this sense, it is considered that there is no great concern about the impact on the NAS specification. Thus, the wake-up timer does not affect (or only has a minute effect on) the operation of the NAS as long as the processing is done by the AS.

When an OAM based solution is desired, the gNB 200 always selects the option of not configuring the timer with the RRC Release message. Hence, this optional function is not harmful and ensures an efficient operation and interoperability of the network 5.

Thus, it is preferable to introduce a wake-up timer in order for the gNB 200 to control the NCR-MT 520A in the RRC idle state to establish an RRC connection. Further, when the wake-up timer expires, it is necessary to examine whether the AS operates as having received a paging message, that is, whether the AS indicates the UE-ID to the NAS.

Furthermore, the timer value needs to be examined. According to the existing mechanism related to access restriction/disallowing in the RRC idle state, 300 seconds (or 5 minutes) is a typical time period for the UE to exclude disallowed cells from candidates for cell reselection, for example, and the time period may be taken as the minimum value of this timer. The gNB 200 cannot use the NCR apparatus 500A during a period of low traffic, for example, at night, and can release the NCR apparatus 500A to the RRC idle state. Hence, it is considered to be appropriate when the upper limit of the timer value is 12 hours. Assuming the timer value is 8 bits, the mapping is, for example, {300 seconds (5 minutes), 10 minutes, 30 minutes, 60 minutes (1 hour), 3 hours, 12 hours}. Thus, the range of the value of the wake-up timer is preferably 300 seconds to 12 hours at the maximum, for example. Further, it needs to determine how many bits the wake-up timer configuration is (for example, baseline is 8 bits).

Another possibility is the prohibit timer. This makes the NCR-MT 520A start the timer (when configured by the RRC Release message), and while the timer is running, the NCR-MT 520A is disallowed to initiate the RRC connection establishment procedure. Using this solution makes the above mentioned problems (in particular, the OAM server implementation of frequent automatic generation of the DL traffic such as the keep-alive message and “ping-pong” RRC state transition) be solved and enables the gNB 200 to control the NCR apparatus 500A.

It is also conceivable to combine these timers in order to support various implementations. That is, one timer functions as both the wake-up timer and the prohibit timer. In other words, the NCR-MT 520A in the RRC idle state may continuously be controlled by the network 5. It is considered to be more efficient because two separate timers are not required for both the wake-up timer and the prohibit timer. Thus, it is efficient and feasible to integrate the wake-up timer and the prohibit timer into one timer.

Further, it is necessary to further examine whether to disallow the NCR-MT 520A from initiating the RRC connection establishment while the wake-up timer is running. That is, the wake-up timer also functions as the prohibit timer. Establishment of an RRC connection by the UL traffic (example: UL OAM client packet) is disallowed, but it is worth examining whether the same is true for the DL traffic (for example, DL OAM server packet). When establishment of the RRC connection by the DL traffic is disallowed, it means that the network 5/OAM client cannot reach the NCR apparatus 500A while the timer is running. This is not a desirable operation from the operator's perspective. Hence, the prohibit timer needs to be applied only to the RRC connection establishment with the UL traffic. However, in other cases, it is considered that the prohibit timer is to be applied to both the UL traffic and the DL traffic. For example, it is a case when the gNB 200 intends to prevent the NCR-MT 520A from returning to the RRC connected state because of the DL traffic (for example, keep-alive message of the OAM server). Accordingly, it is another issue whether the restriction above can be configured by the gNB 200. Thus, it needs to be further examined whether the prohibit timer, which is running, is applied only to the UL traffic (for example, by the OAM client), that is, whether an RRC connection establishment is allowed for the DL traffic (for example, by the OAM server or by paging reception). Further, it needs to be further examined whether such restriction can be configured by the gNB 200, that is, whether the prohibit timer is applied only to the UL traffic or to both the DL traffic and the UL traffic.

### REFERENCE SIGNS

1: Mobile communication system
100: UE
200: gNB
210: Transmitter
220: Receiver
230: Controller
240: Backhaul communicator
300A: AMF
400: OAM server
500A: NCR apparatus
510A: NCR-Fwd
520A: NCR-MT
500B: RIS apparatus
510B: RIS-Fwd
520B: RIS-MT
511A: Wireless unit
511a: Antenna
511b: RF circuit
511c: Directivity controller
512A: NCR controller
512B: RIS controller
521: Receiver
522: Transmitter
523: Controller
530: Interface

1. A communication method executed by a relay apparatus comprising a relay device configured to perform a relay operation of relaying a radio signal transmitted between a network node and a user equipment and a control terminal configured to receive a control signal used for control of the relay device from the network node, the communication method comprising the steps of:
starting, by the control terminal, a timer restricting initiation of a radio resource control (RRC) connection establishment procedure of transitioning to an RRC connected state upon having transitioned from the RRC connected state to an RRC idle state;
restricting so as not to initiate the procedure, while the timer is running, in response to a cause of the RRC connection establishment not being a predetermined cause; and
initiating the procedure, while the timer is running, in response to the cause of the RRC connection establishment being the predetermined cause.

2. The communication method according to claim 1, wherein
the predetermined cause is an occurrence of an incoming call from a network to the control terminal.

3. The communication method according to claim 1, wherein
the predetermined cause is an occurrence of signaling transmitted from the control terminal to a network.

4. The communication method according to claim 1, further comprising:
receiving, by the control terminal, configuration information designating the predetermined cause from the network node.

5. The communication method according to claim 1, further comprising:
receiving, from the network node, an RRC Release message configured to cause the control terminal to transition to the RRC idle state,
wherein the RRC Release message comprises a timer configuration value designating a time length of the timer.

6. A relay apparatus, comprising:
a relay device configured to perform a relay operation of relaying a radio signal transmitted between a network node and a user equipment; and
a control terminal configured to receive a control signal used for control of the relay device from the network node,
wherein the control terminal:
starts a timer restricting initiation of a radio resource control (RRC) connection establishment procedure of transitioning to an RRC connected state upon having transitioned from the RRC connected state to an RRC idle state;
restricts so as not to initiate the procedure, while the timer is running, in response to a cause of performing the RRC connection establishment not being a predetermined cause; and
initiates the procedure, while the timer is running, in response to the cause of performing the RRC connection establishment being the predetermined cause.
